(19) United States
(12) Patent Application Publication
(10) Pub. No.: US 2020/0404324 A1
(43) Pub. Date: Dec. 24, 2020

(54) SIGNALING FOR INTRA CODING OF VIDEO DATA

(71) Applicant: QUALCOMM Incorporated, San Diego, CA (US)

(72) Inventors: Luong Pham Van, San Diego, CA (US); Geert Van der Auwera, Del Mar, CA (US); Adarsh Krishnan Ramasubramonian, Irvine, CA (US); Han Huang, San Diego, CA (US); Marta Karczewicz, San Diego, CA (US)

(21) Appl. No.: 16/893,094

(22) Filed: Jun. 4, 2020

Related U.S. Application Data
(60) Provisional application No. 62/863,738, filed on Jun. 19, 2019.
(60) Provisional application No. 62/866,434, filed on Jun. 25, 2019.

(51) Int. Cl. H04N 19/593; H04N 19/70; H04N 19/91; H04N 19/61

(52) U.S. Cl. CPC H04N 19/593; H04N 19/61; H04N 19/91; H04N 19/70

(57) ABSTRACT

An example device for coding video data includes a memory configured to store video data; and one or more processors implemented in circuitry and configured to: code a value of a syntax element for a block of the video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; form a prediction block for the block according to the value of the syntax element; and code the block using the prediction block.

This application claims the benefit of U.S. Provisional Application No. 62/863,738, filed Jun. 19, 2019, and U.S. Provisional Application No. 62/866,434, filed Jun. 25, 2019, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques that may efficiently reduce the overhead for intra signaling. The techniques of this disclosure are mainly described with respect to Versatile Video Coding (VVC)/the upcoming ITU-T H.266 video coding standard, beyond ITU-T H.265/High Efficiency Video Coding (HEVC), although these techniques may also be applied to other future video coding standards.

Conventional intra-prediction modes include directional intra-prediction modes, DC prediction mode, and planar mode. VVC has introduced new intra-prediction modes such as, for example, intra sub-partition coding (ISP) partitioning mode, matrix intra-prediction (MIP) mode, and blurred differential pulse code modulation (BDPCM) mode. VVC has also introduced syntax elements related to these various modes, which are generally signaled before the conventional “regular” intra-prediction syntax elements in a block syntax structure. In order to improve efficiency of signaled data for a bitstream, the techniques of this disclosure include signaling data indicating whether a “regular” mode (e.g., directional, DC, or planar mode) is used to predict a block of video data, and if so, syntax elements for other intra-prediction modes (e.g., ISP, MIP, BDPCM, and the like) can be skipped. In this manner, only relevant intra-prediction syntax elements can be coded, thereby reducing signaling overhead for intra-predicted blocks of video data. Likewise, processing efficiency can be improved, because video encoders and decoders can avoid encoding/decoding these syntax elements when they are not needed.

In one example, a method of coding video data includes coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; forming a prediction block for the block according to the value of the syntax element; and coding the block using the prediction block.

In another example, a device for coding video data includes a memory configured to store video data; and one or more processors implemented in circuitry and configured to: code a value of a syntax element for a block of the video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; form a prediction block for the block according to the value of the syntax element; and code the block using the prediction block.

In another example, a computer-readable storage medium has stored thereon instructions that, when executed, cause a processor to: code a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; form a prediction block for the block according to the value of the syntax element; and code the block using the prediction block.

In another example, a device for coding video data includes means for coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; means for forming a prediction block for the block according to the value of the syntax element; and means for coding the block using the prediction block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a conceptual diagram illustrating intra-prediction directions where arrows point to reference samples.

FIG. 4 is a conceptual diagram illustrating an example rectangular block where “closer” reference samples are not used, but further reference samples may be used, due to a restriction of intra-prediction direction being in the range of −135 degrees to 45 degrees.

FIGS. 5A and 5B are conceptual diagrams illustrating example mode mapping processes for modes outside of a diagonal direction range.

FIG. 6 is a conceptual diagram illustrating an example mode mapping process for modes outside of a diagonal direction range for a vertical non-square block.

FIG. 7 is a conceptual diagram illustrating example wide angle prediction modes in addition to 65 angular modes.

FIG. 8 is a conceptual diagram illustrating additional example wide angle prediction modes in addition to 65 angular modes.

FIGS. 9A and 9B are conceptual diagrams illustrating examples of divisions of blocks.

FIG. 10 is a conceptual diagram illustrating example reference samples from multiple reference lines that may be used for intra-prediction of a block.

FIG. 11 is a conceptual diagram illustrating an example affine linear weighted intra-prediction (ALWIP) process.

FIG. 12 is a block diagram illustrating an example video encoder that may perform the techniques of this disclosure.

FIG. 13 is a block diagram illustrating an example video decoder that may perform the techniques of this disclosure.

FIG. 14 is a flowchart illustrating an example method for encoding a current block in accordance with the techniques of this disclosure.

FIG. 15 is a flowchart illustrating an example method for decoding a current block in accordance with the techniques of this disclosure.

FIG. 16 is a flowchart illustrating an example method for entropy encoding prediction information for an intra-prediction mode according to techniques of this disclosure.

FIG. 17 is a flowchart illustrating an example method for entropy decoding prediction information for an intra-prediction mode according to techniques of this disclosure.

### DETAILED DESCRIPTION

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. Additionally, ITU-T H.265/High-Efficiency Video Coding (HEVC), was finalized by the Joint Collaboration Team on Video Coding (JCT-VC) of ITU-T Video Coding Experts Group (VCEG) and ISO/IEC Motion Picture Experts Group (MPEG) in April 2013.

The Joint Video Experts Team (WET), a collaborative team formed by MPEG and ITU-T Study Group 16's VCEG is working on a new video coding standard to be known as Versatile Video Coding (VVC). The primary objective of VVC is to provide a significant improvement in compression performance over the existing HEVC standard, aiding in deployment of higher-quality video services and emerging applications, such as 360° omnidirectional immersive multimedia and high-dynamic-range (HDR) video. The development of the VVC standard is expected to be completed in 2020. A working draft of VVC, henceforth referred to as “VVC WD5” in this document, is B. Bross, J. Chen, S. Liu, “Versatile Video Coding (Draft 5)”, WET-N1001.

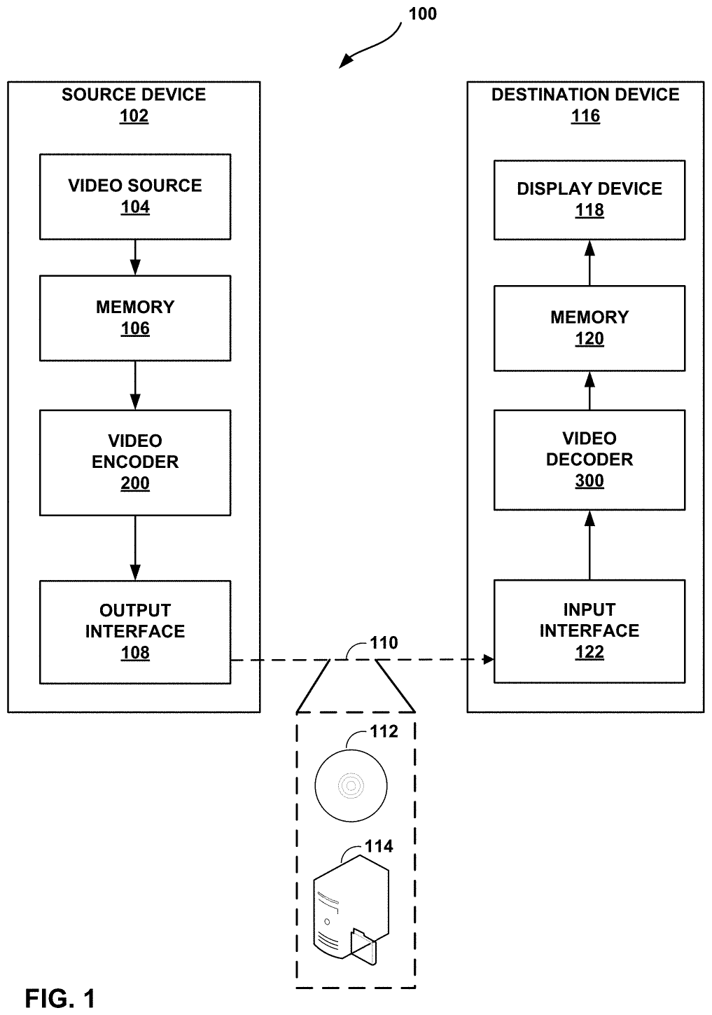

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for coding intra-prediction information. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for coding intra-prediction information. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A draft of the VVC standard is described in Bross, et al. “Versatile Video Coding (Draft 5),” Joint Video Experts Team (JVET) of ITU-T SG 16 WP 3 and ISO/IEC JTC 1/SC 29/WG 11, 14th Meeting: Geneva, CH, 19-27 Mar. 2019, JVET-N1001-v3 (hereinafter “VVC Draft 5”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) partitions. A triple tree partition is a partition where a block is split into three sub-blocks. In some examples, a triple tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Directional prediction modes, planar mode, and DC mode may be referred to as “regular” intra-prediction modes. That is, these modes are available in HEVC. VVC additionally provides alternative intra-prediction modes, such as intra sub-partition coding (ISP) partitioning mode, matrix intra-prediction (MIP) mode, and blurred differential pulse code modulation (BDPCM) mode. As discussed in greater detail below, these additional intra-prediction modes of VVC (which may also be included in other video coding standards beyond VVC) have associated syntax elements in, e.g., a block syntax structure. However, this disclosure recognizes that when a block is coded using one of the regular coding modes, the syntax elements for the intra-prediction modes beyond the regular intra-prediction modes need not be coded.

Thus, according to the techniques of this disclosure, video encoder 200 may encode a value for a syntax element for a block, the syntax element indicating whether the block is encoded using an intra-prediction mode using a zero reference line index, not encoded using ISP partitioning mode, not encoded using MIP mode, and not encoded using BDPCM mode. In examples where the block is not predicted using the ISP partitioning mode, the MIP mode, or the BDPCM mode, the block may be predicted using a “regular” intra-prediction mode, e.g., a mode using a zero reference index line. Such a mode may be an intra-prediction mode of a most probable mode (MPM) list, or a remaining intra-prediction mode (outside of the MPM list).

Video encoder 200 may encode the value for the syntax element indicating that the block is predicted using the regular intra-prediction mode at a position in a block syntax structure that would occur before syntax elements for the ISP partitioning mode, the MIP mode, and the BDPCM mode. In this manner, video encoder 200 need not encode the syntax elements for the ISP partitioning mode, the MIP mode, and the BDPCM mode.

Video encoder 200 may determine that one of the regular intra-prediction modes is to be used to predict the block using rate-distortion optimization (RDO) techniques. For example, video encoder 200 may determine that one of the regular intra-prediction modes yields a best RDO metric than other tested intra-prediction modes. Alternatively, if one of the non-regular modes yields the best RDO metric, video encoder 200 may select the mode that yields the best RDO metric of the tested modes.

In the case where one of the regular intra-prediction modes, included in the MPM list, has the best tested RDO metric, video encoder 200 may code a value indicating whether the MPM list is used to determine the intra-prediction mode for the block. In the case the intra-prediction mode is included in the MPM list, video encoder 200 may further code a value for an index into the MPM that identifies the intra-prediction mode in the MPM. Alternatively, video encoder 200 may code a value for an MPM remainder syntax element that identifies the intra-prediction mode.

As an alternative, when one of the non-regular intra-prediction modes yields the best RDO metric, video encoder 200 may encode the syntax elements for the selected non-regular intra-prediction mode, e.g., one of the ISP partitioning mode, the MIP mode, or the BDPCM mode.

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

In accordance with the techniques of this disclosure, video decoder 300 may decode a value for a syntax element representing whether a regular intra-prediction mode is used to predict a current block of video data. If the regular intra-prediction mode is used, video decoder 300 may determine that values for syntax elements for other intra-prediction modes, such as the ISP partitioning mode, the MIP mode, and the BDPCM mode, will not be included in the video bitstream, and thus, avoid attempting to decode the values for these syntax elements. Furthermore, video decoder 300 may determine a value indicating whether the intra-prediction mode is included in an MPM, and either decode an index into the MPM or an MPM remainder value accordingly. Video decoder 300 may use the intra-prediction mode indicated by the index or the MPM remainder to determine the intra-prediction mode to be used to predict the current block, in this case. Alternatively, video decoder 300 may decode the values of syntax elements for non-regular intra-prediction modes when a regular intra-prediction mode is not used. Video decoder 300 may form a prediction block for the current block using the signaled intra-prediction mode.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

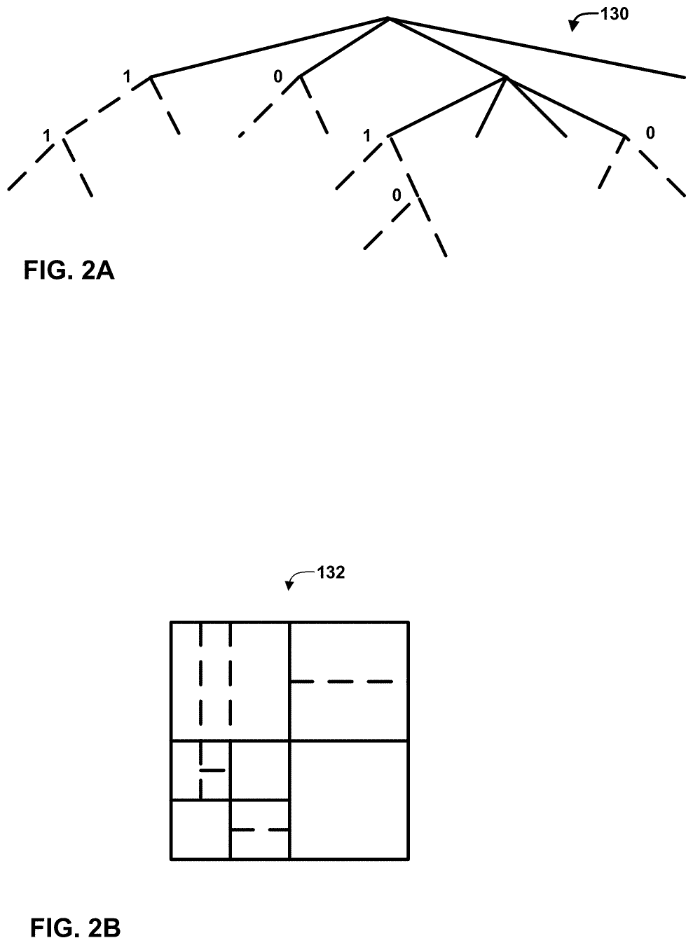

FIGS. 2A and 2B are conceptual diagram illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

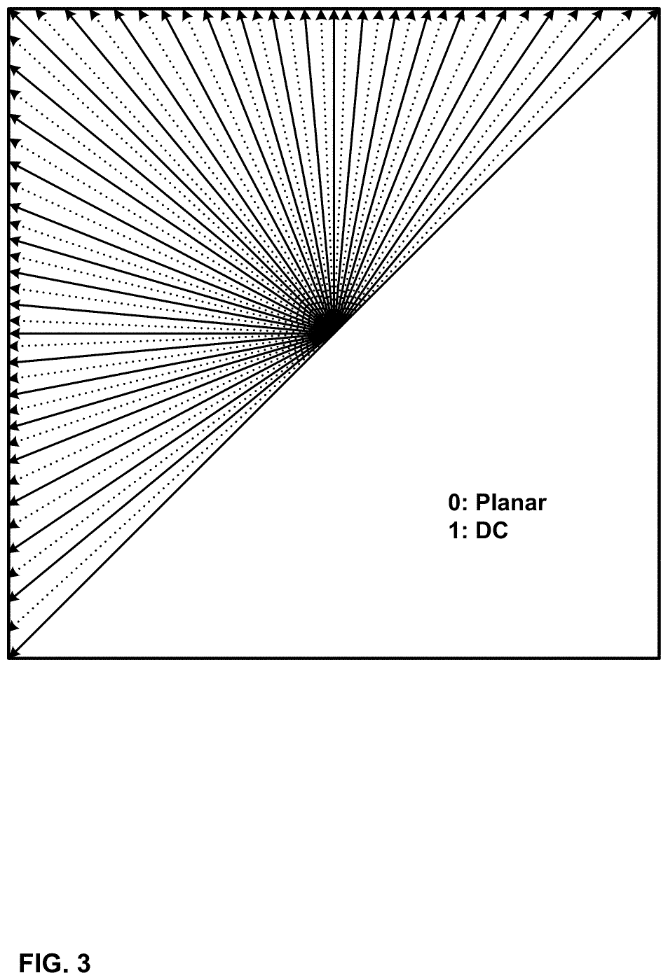

FIG. 3 is a conceptual diagram illustrating intra-prediction directions where arrows point to reference samples. Intra-prediction modes include DC prediction mode, planar prediction mode, and directional (or angular) prediction modes. Directional prediction for square blocks includes directions between −135 degrees to 45 degrees of the current block in the VVC test model 2 (VTM2) (L. Zhao, X. Zhao, S. Liu, X. Li, “CE3-related: Unification of angular intra-prediction for square and non-square blocks,” 12^{th} JVET Meeting, Macau SAR, CN, October 2018, JVET-L0279), as illustrated in FIG. 3.

In VTM2, the block structure used for specifying the prediction block for intra-prediction is not restricted to be square (width w=height h). Rectangular or non-square prediction blocks (w>h or w<h) can increase the coding efficiency based on the characteristics of the content.

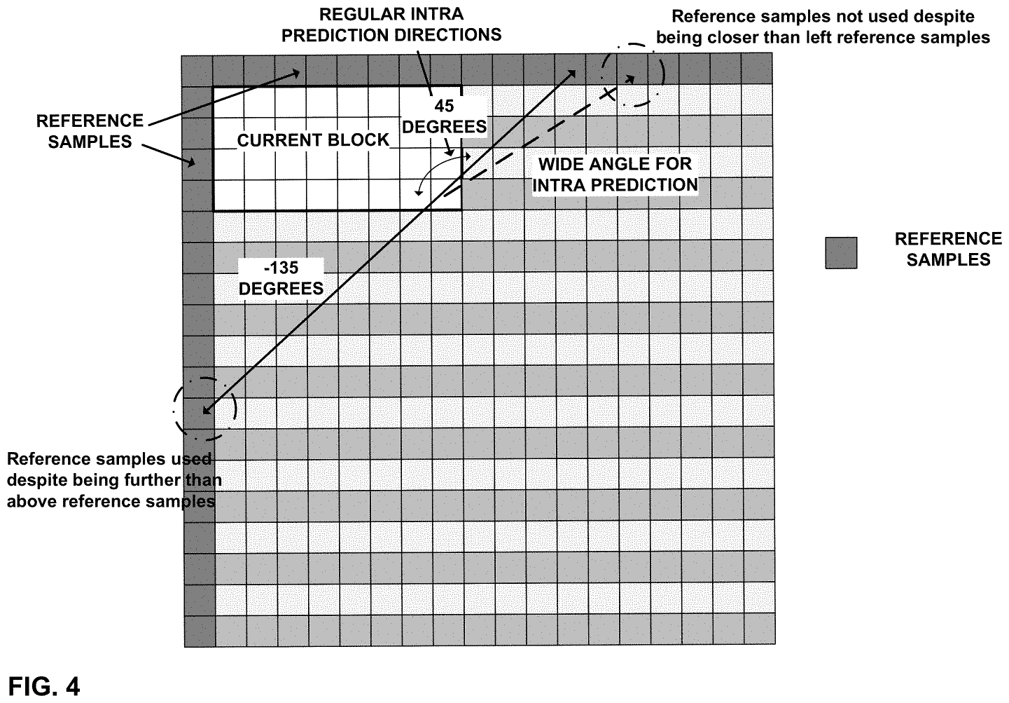

FIG. 4 is a conceptual diagram illustrating an example rectangular block where “closer” reference samples are not used, but further reference samples may be used, due to a restriction of intra-prediction direction being in the range of −135 degrees to 45 degrees.

In such rectangular blocks, restricting the direction of intra-prediction to be within −135 degrees to 45 degrees can result in situations where farther reference samples are used rather than closer reference samples for intra-prediction. Such a design is likely to have an impact on the coding efficiency; it is more beneficial to have the range of restrictions relaxed so that closer reference samples (beyond the −135 to 45-degree angle) can be used for prediction. An example of such a case is shown in FIG. 4, which represents an example of wide angles that are adopted in VTM2.

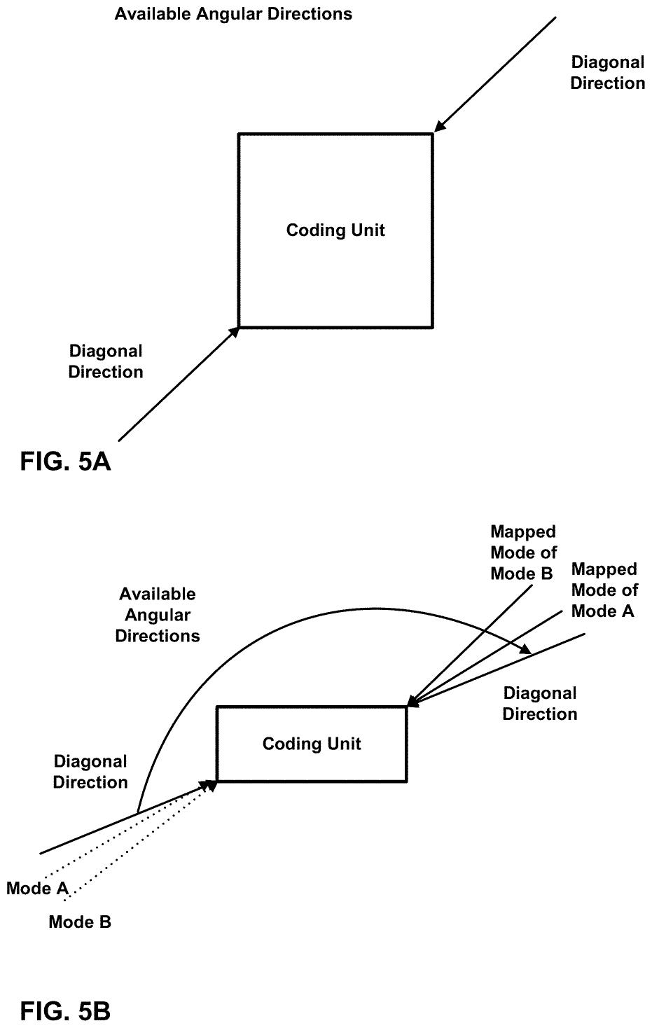

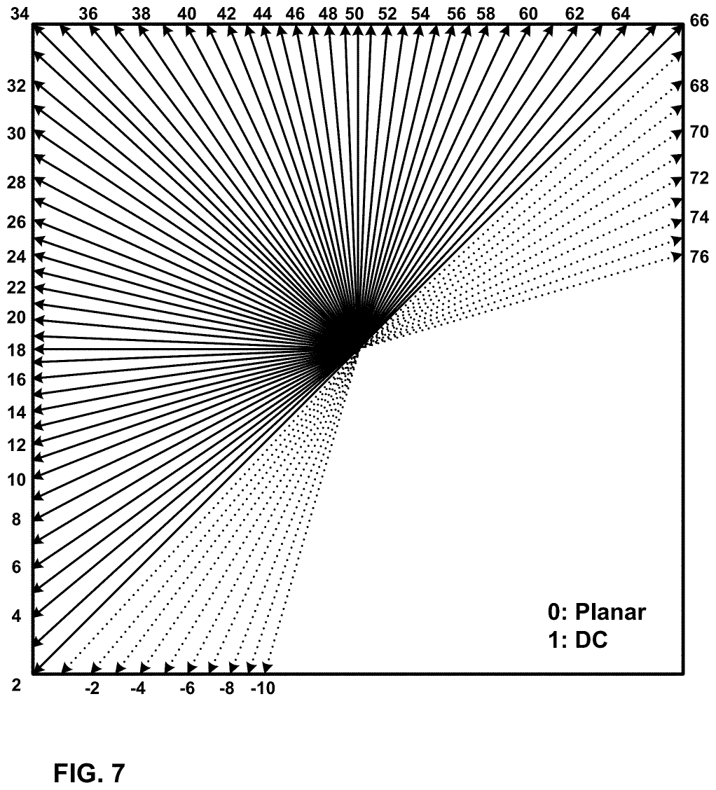

During the 12th JVET meeting, a modification of wide-angle intra-prediction was adopted into VTM3 (L. Zhao, X. Zhao, S. Liu, X. Li, “CE3-related: Unification of angular intra-prediction for square and non-square blocks,” 12th JVET Meeting, Macau SAR, CN, October 2018, JVET-L0279; B. Bross, J. Chen, S. Liu, “Versatile Video Coding (Draft 3),” 12th JVET Meeting, Macau SAR, CN, October 2018, JVET-L1001). This adoption includes two modifications to unify the angular intra-prediction for square and non-square blocks. Firstly, angular prediction directions are modified to cover diagonal directions of all block shapes. Secondly, all angular directions are kept within the range between the bottom-left diagonal direction and the top-right diagonal direction for all block aspect ratios (square and non-square) as illustrated in FIGS. 5A and 5B. In addition, the number of reference samples in the top reference row and left reference column are restricted to 2*width+1 and 2*height+1 for all block shapes. An illustration of wider angles that are adopted in VTM3 is provided in FIG. 7 below. Although VTM3 defines 95 modes, for any block size, only 67 modes are allowed. The exact modes that are allowed depend on the ratio of block width to height. This is done by restricting the mode range for certain blocks sizes.

Table 1 below specifies the mapping table between predModeIntra and the angle parameter intraPredAngle in VTM3. The angular modes corresponding with non-square block diagonals are highlighted in blue. The vertical and horizontal modes are highlighted in green for reference. Square block diagonal modes are highlighted in yellow. In the following, angular modes with a positive intraPredAngle value are referred to as positive angular modes (mode index <18 or >50), while angular modes with a negative intraPredAngle value are referred to as negative angular modes (mode index >18 and <50).

TABLE 1

| predModeIntra | −14 | −13 | −12 | −11 | −10 | −9 | −8 | −7 | −6 |
|---|---|---|---|---|---|---|---|---|---|
| intraPredAngle | 512 | 341 | 256 | 171 | 128 | 102 | 86 | 73 | 64 |

| predModeIntra | −5 | −4 | −3 | −2 | −1 | 2 | 3 | 4 | 5 |
|---|---|---|---|---|---|---|---|---|---|
| intraPredAngle | 57 | 51 | 45 | 39 | 35 | 32 | 29 | 26 | 23 |
| predModeIntra | 6 | 7 | 8 | 9 | 10 | 11 | 12 | 13 | 14 |
| intraPredAngle | 20 | 18 | 16 | 14 | 12 | 10 | 8 | 6 | 4 |
| predModeIntra | 15 | 16 | 17 | 18 | 19 | 20 | 21 | 22 | 23 |
| intraPredAngle | 3 | 2 | 1 | 0 | −1 | −2 | −3 | −4 | −6 |

| predModeIntra | 24 | 25 | 26 | 27 | 28 | 29 | 30 | 31 | 32 |
|---|---|---|---|---|---|---|---|---|---|
| intraPredAngle | −8 | −10 | −12 | −14 | −16 | −18 | −20 | −23 | −26 |

| predModeIntra | 33 | 34 | 35 | 36 | 37 | 38 | 39 | 40 | 41 |
|---|---|---|---|---|---|---|---|---|---|
| intraPredAngle | −29 | −32 | −29 | −26 | −23 | −20 | −18 | −16 | −14 |

| predModeIntra | 42 | 43 | 44 | 45 | 46 | 47 | 48 | 49 | 50 |
|---|---|---|---|---|---|---|---|---|---|
| intraPredAngle | −12 | −10 | −8 | −6 | −4 | −3 | −2 | −1 | 0 |

| predModeIntra | 51 | 52 | 53 | 54 | 55 | 56 | 57 | 58 | 59 |
|---|---|---|---|---|---|---|---|---|---|
| intraPredAngle | 1 | 2 | 3 | 4 | 6 | 8 | 10 | 12 | 14 |
| predModeIntra | 60 | 61 | 62 | 63 | 64 | 65 | 66 | 67 | 68 |
| intraPredAngle | 16 | 18 | 20 | 23 | 26 | 29 | 32 | 35 | 39 |

| predModeIntra | 69 | 70 | 71 | 72 | 73 | 74 | 75 | 76 | 77 |
|---|---|---|---|---|---|---|---|---|---|
| intraPredAngle | 45 | 51 | 57 | 64 | 73 | 86 | 102 | 128 | 171 |

| predModeIntra | 78 | 79 | 80 |
|---|---|---|---|
| intraPredAngle | 256 | 341 | 512 |

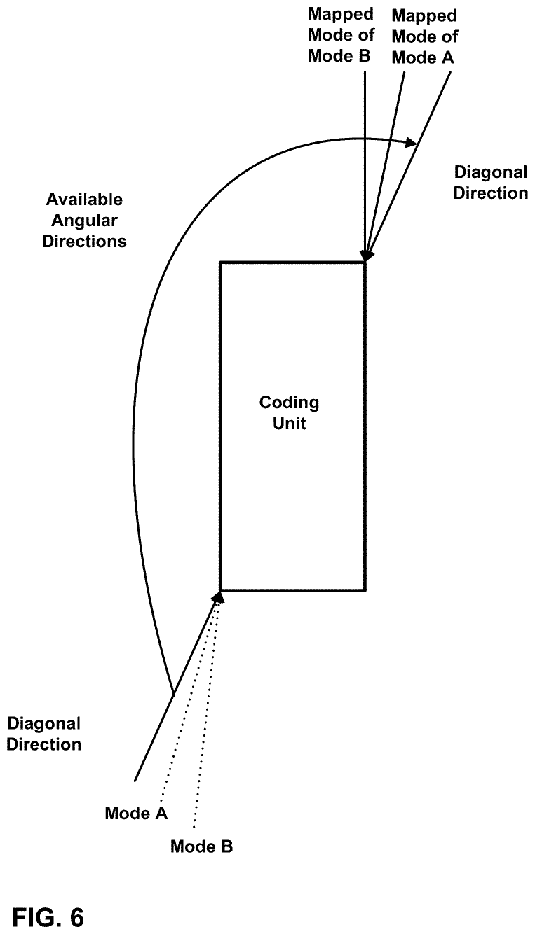

FIGS. 5A and 5B are conceptual diagrams illustrating example mode mapping processes for modes outside of a diagonal direction range. FIG. 6 is a conceptual diagram illustrating an example mode mapping process for modes outside of a diagonal direction range for a vertical non-square block. In particular, FIGS. 5A, 5B, and 6 illustrate mode remapping process for modes outside of the diagonal direction range using Table 1 above. In FIG. 5A, the current block is square, and therefore, no angular mode remapping is necessary. In FIG. 5B, angular mode remapping is shown for a horizontal non-square block. In FIG. 6, angular mode remapping is shown for a vertical non-square block.

FIG. 7 is a conceptual diagram illustrating example wide angle prediction modes in addition to 65 angular modes. The wide angles in this example include the intra-prediction angles corresponding to modes −1 to −10 and 67 to 76.

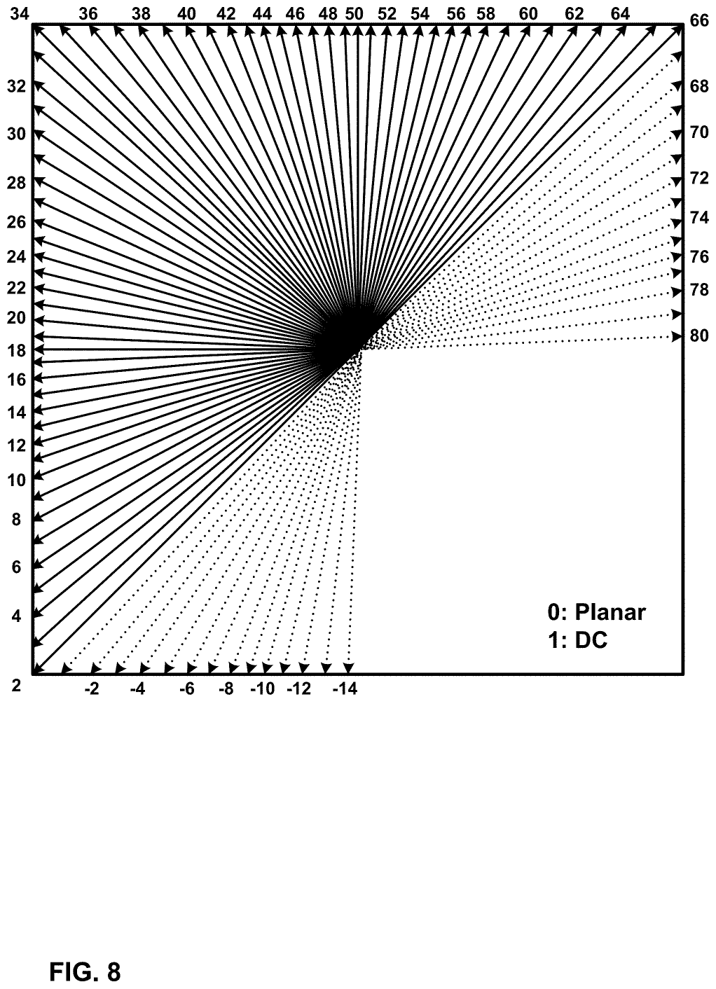

FIG. 8 is a conceptual diagram illustrating additional example wide angle prediction modes in addition to 65 angular modes. The wide angles in this example include the intra-prediction angles corresponding to modes −1 to −14 and 67 to 80.

The inverse angle parameter invAngle may be derived based on intraPredAngle as follows:

$$invAngle = Round ( \frac{256 * 32}{intraPredAngle} ) \qquad ( 1 )$$

Note that intraPredAngle values that are multiples of 32 (0, 32, 64, 128, 256, 512) may be ensured to always correspond with prediction from non-fractional reference array samples, as is the case in the VTM3 specification.

Table 2 below is a table of diagonal modes corresponding with various block aspect ratios:

TABLE 2

| Block aspect ratio | |
|---|---|
| (width/height) | Diagonal modes |
| 1 (square) | 2, 34, 66 |
| 2 | 8, 28, 72 |
| 4 | 12, 24, 76 |
| 8 | 14, 22, 78 |
| 16 | 16, 20, 80 |
| 1/2 | −6, 40, 60 |
| 1/4 | −10, 44, 56 |
| 1/8 | −12, 46, 54 |
| 1/16 | −14, 48, 52 |

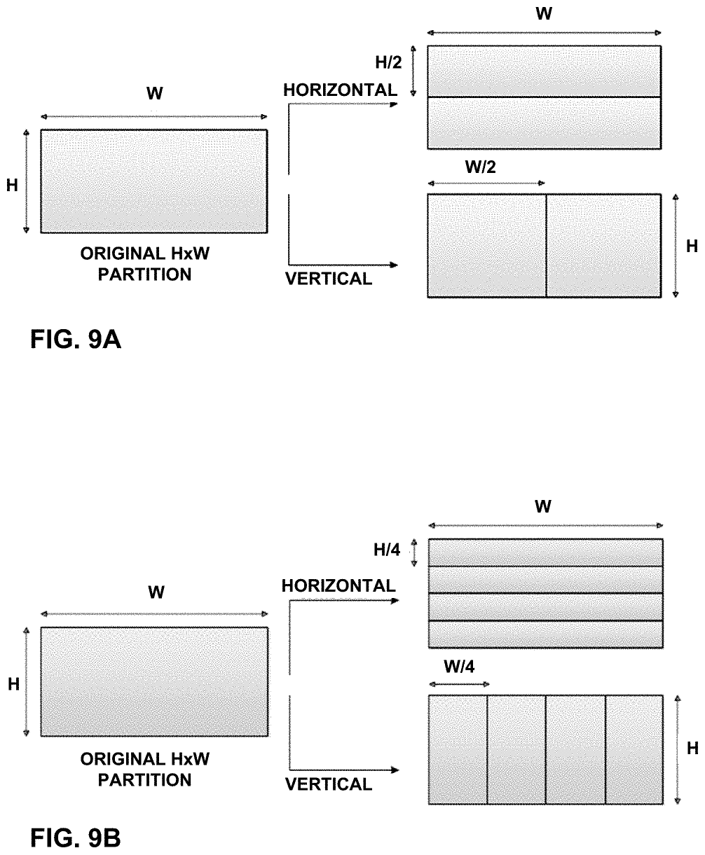

FIGS. 9A and 9B are conceptual diagrams illustrating examples of divisions of blocks. In particular, these divisions may be used for intra sub-partition coding (ISP), described in J. Pfaff, B. Stallenberger, M. Schäfer, P. Merkle, P. Helle, T. Hinz, H. Schwarz, D. Marpe, T. Wiegand (HHI) “CE3: Affine linear weighted intra-prediction (CE3-4.1, CE3-4.2)”, JVET-N0217. In ISP, a block (e.g., a coding block) is split into two or four sub-blocks, where each sub-block within the block is reconstructed in decoding order before the reconstruction of the subsequent subblock in decoding order. FIG. 9A illustrates examples of splitting into two sub-blocks, while FIG. 9B illustrates examples of splitting into four sub-blocks. In VVC WD5, ISP is only applied to luma coding blocks; the reference samples for these ISP-coded blocks are restricted to be from the reference line that is closest to the coding block (refer to MRLIdx=0 from Section 2.4 of VVC WD5).

One bit may be used to signal whether a coding block is split into ISPs, and a second bit may be used to indicate the split type: horizontal or vertical. Based on the intra mode and the split type used, two different classes of processing orders may be used, which are referred to as normal and reversed order. In the normal order, the first sub-partition to be processed is the one containing the top-left sample of the CU and then continuing downwards (horizontal split) or rightwards (vertical split). On the other hand, the reverse processing order either starts with the sub-partition containing the bottom-left sample of the CU (horizontal split) and continues upwards or starts with the sub-partition containing the top-right sample of the CU and continues leftwards (vertical split).

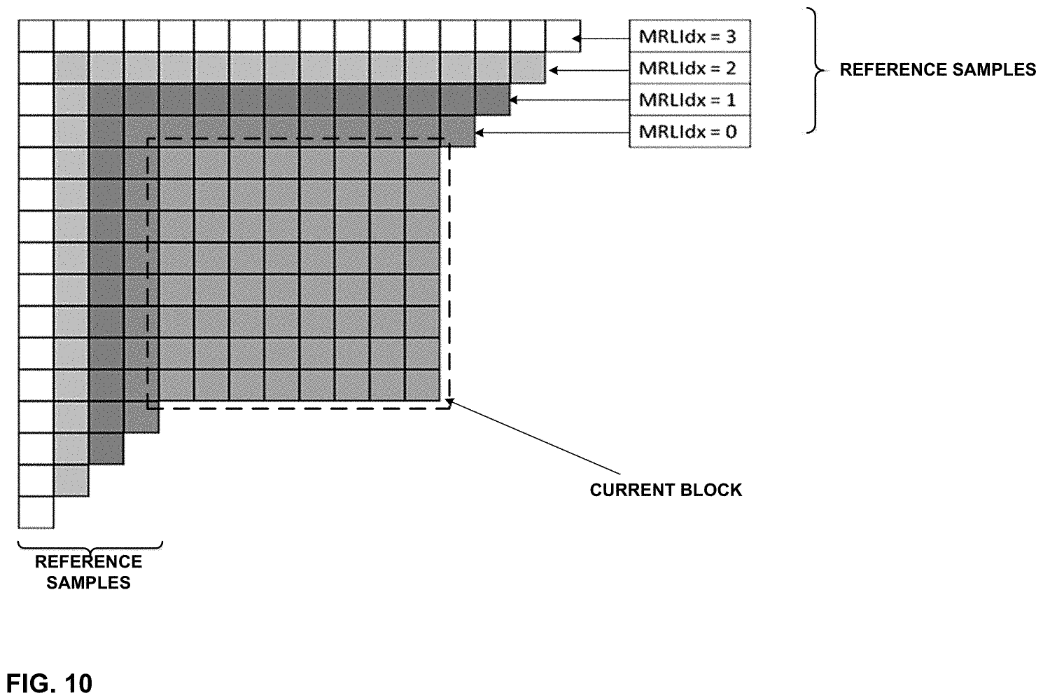

FIG. 10 is a conceptual diagram illustrating example reference samples from multiple reference lines that may be used for intra-prediction of a block. The samples in the neighborhood of a coding block may be used for intra-prediction of the block. Typically, the reconstructed reference sample lines that are closest to the left and the top boundaries of the coding block are used as the reference samples for intra-prediction. However, VVC WD5 also enables other samples in the neighborhood of the coding block to be used as reference samples. FIG. 10 illustrates example reference sample lines that may be used for intra-prediction. For each coding block, an index may be signaled that indicates the reference line that is used.

In VVC WD5, only reference lines with MRLIdx equal to 0, 1, and 3 can be used. The index to the reference line used for coding the block (values 0, 1, and 2 indicating lines with MRLIdx 0, 1 and 3, respectively) is coded with truncated unary codeword. Planar and DC modes are not used because the reference line used has MRLIdx>0.

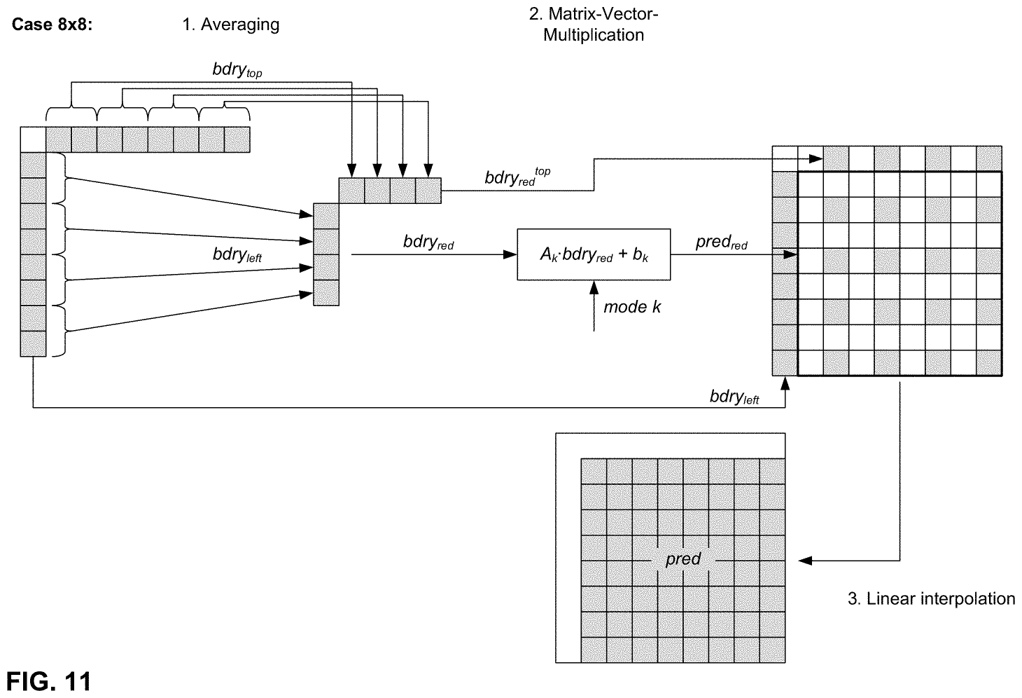

FIG. 11 is a conceptual diagram illustrating an example affine linear weighted intra-prediction (ALWIP) process. According to ALWIP, a video coder generates a prediction block for a block from the neighboring reference samples using an affine linear weighted prediction model. The neighboring samples are first processed; in some cases, neighboring samples are downsampled; the downsampled samples are then used to derive (using the affine model) a set of reduced samples which resembles an intermediate downsampled version of the predicted samples. The final prediction is obtained by upsampling (as necessary) the intermediate values. Note that ALWIP may also be referred to as matrix intra-prediction (MIP).

An illustration of the ALWIP process is given in FIG. 11. The reference samples of the block (also referred to as boundary samples) are downsampled to obtain reduced boundary samples. The vector representation of the boundary samples, bdry_{red}, is multiplied with a matrix Aₖ and an offset/bias term bₖ is added to obtain a downsampled version of the predicted block, pred_{red}. The final prediction is obtained by upsampling these predicted samples pred_{red} along with the boundary samples. The matrix Aₖ and an offset/bias vector bₖ are chosen based on the mode value indicated for the block.

The derivation of intermediate predicted samples uses an affine linear weighted prediction model. Three types are defined, and the number of the intermediate samples derived differ for each type as follows:
1) 4×4 for block sizes of width and height both equal to 4
2) 8×8 for block sizes of width and height both less than equal to 8 except when both width and height are equal to 4 (i.e., 4×8, 8×4 and 8×8 blocks)
3) 16×16 for blocks where at least one of width and height is greater than 8.

In each of these three cases, different number of ALWIP modes are used: 35, 19, and 11, respectively.

The signaling of the ALWIP includes:
a) A flag (alwip_flag) to indicate that that the current block is coded with ALWIP.
b) When the block is coded with ALWIP, another flag is signalled to indicate whether the current block is coded with an ALWIP-MPM mode or not.
   a. If ALWIP MPM, the MPM index is signalled.
   b. Else, an index to the remaining mode value is signalled.

The alwip_flag is context coded with four contexts allowed:
If block width>2*height or height>2*width, context 3 is used.
Else context ctxId is used, where ctxId is derived as follows:
   Initialized ctxId to 0
   If left neighbouring block is coded with ALWIP, ctxId++
   If above neighbouring block is coded with ALWIP, ctxId++

The derivation of the ALWIP MPM involves the following steps:
1) LeftIntraMode and AboveIntraMode are initialized to −1
2) If left neighbouring block is intra coded
   a. If the left neighbouring block is coded with ALWIP mode L
      i. If L is of the same ALWIP type as the current block, then LeftIntraMode is set equal to L.
   b. The intra mode of left neighbouring block is mapped to an ALWIP mode of the same type as the current block, and assigned to LeftIntraMode.
3) If above neighbouring block is intra coded
   a. If the above neighbouring block is coded with ALWIP mode A
      i. If A is of the same ALWIP type as the current block, then AboveIntraMode is set equal to A.
   b. The intra mode of above neighbouring block is mapped to an ALWIP mode of the same type as the current block, and assigned to AboveIntraMode.
4) The MPMs are then derived based on LeftIntraMode and AboveIntraMode.

In this disclosure, blocks coded with ALWIP may be referred to as ALWIP-coded blocks or ALWIP blocks; other blocks (coded with regular intra-prediction, intra sub-partitions, or multiple reference lines) may be referred to as non-ALWIP blocks.

For an intra coding unit, video encoder 200 may signal the mode and the directional prediction mode (IPM), including planar or DC mode, to video decoder 300.

In WD5, the mode of an intra coding unit may be blurred differential pulse code modulation (BDPCM), pulse code modulation (PCM), MIP, ISP, or regular intra mode, in which BDPCM currently supports only screen video contents. In addition, the reference line index is also signalled using a context encoder for the modes which support non-zero reference line index. In WD5, non-zero reference lines is disabled for the MIP, ISP, PCM, and BDPCM modes, and the DC and Planar prediction modes. The detail of signaling for intra mode of MIP, ISP, and the reference index are discussed above.

VVC WD5 has 95 intra modes defined—93 angular modes and 2 non-angular modes (Planar and DC). For a given luma coding block, however, only 67 modes are allowed. The prediction mode that is used for intra mode coding of luma is signalled in the bitstream. For efficient signaling of intra modes, a list of most probable modes (MPM list) is specified.

In VVC WD5, the MPM list derivation is unified for intra coded modes except MIP. In the unified MPM list, the first candidate is planar mode except for a non-zero reference line index block. A flag (intra_luma_mpm_flag) is signalled using context coding to indicate if the IPM of a block is present in the MPM list or not. The MPM flag, however, is not signalled for ISP and non-zero reference line index blocks since the prediction mode of such blocks is restricted to be in the MPM list. When the IPM of a block is in the MPM list, a non-planar flag (intra_luma_not_planar_flag) is signalled to indicate if the IPM is Planar or not, except for non-zero reference line index blocks. When the IPM is not Planar, the corresponding index to the entry in the list is coded using truncated unary coding.

When the intra mode used is a non-MPM mode (when applicable), the mode may be coded with a truncated binary codeword.

In VVC WD5, eight prediction modes are enabled for an intra chroma block including Planar, vertical, horizontal, DC, 3 cross-component linear model (CCLM) prediction modes, and direct mode (DM). When a chroma block is DM coded, it shares the prediction mode of the corresponding luma blocks. If the prediction mode of luma is coded using intra-block copy (IBC) or pulse code modulation (PCM), the DC mode is assigned to the DM chroma blocks. In addition, if the prediction mode of the corresponding luma block is residual delta pulse code modulation (RDPCM) or blurred differential pulse code modulation (BDPCM) mode, the Planar mode is assigned to the DM chroma blocks.

The syntax structure of the mode signaling the luma intra mode is surrounded by double asterixis (**) in the syntax structure below (Section 7.3.7.5 of WD5: Coding unit syntax):

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCbSizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ) )

| | |
|---|---|
| pcm_alignment_zero_bit | f(1) |

pcm_sample( cbWidth, cbHeight, treeType)

} else {

**if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

if( sps_mip_enabled_flag &&

( Abs( Log2( cbWidth ) − Log2( cbHeight ) ) <= 2 ) &&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpn_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

Else

| | |
|---|---|
| intra_mip_mpm_remainder[ x0 ][ y0 ] | ae(v) |

} else {

if( sps_mrl_enabled_flag && ( ( y0 % CtbSizeY ) > 0 )

)

| | |
|---|---|
| intra_luma_ref_idx[ x0 ][ y0 ] | ae(v) |

if ( sps_isp_enabled_flag &&

intra_luma_ref_idx[ x0 ][ y0 ] = = 0 &&

( cbWidth <= MaxTbSizeY && cbHeight <=

MaxTbSizeY ) &&

| | |
|---|---|
| ( cbWidth * cbHeight > MinTbSizeY * MinTbSizeY ) ) | |
| intra_subpartitions_mode_flag[ x0 ][ y0 ] | ae(v) |

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |

if( intra_luma_ref_idx[ x0 ][ y0 ] = = 0 &&

| | |
|---|---|
| intra_subpartitions_mode _flag[ x0 ][ y0 ] = = 0 ) | |
| intra_luma_mpm_flag[ x0 ][ y0 ] | ae(v) |

if( intra_luma_mpm_flag[ x0 ][ y0 ] ) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v)** |

}

}

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /*

MODE_INTER or MODE_IBC */
...

Since the current version of VVC supports many intra coding modes and intra-prediction modes, the overhead of signaling such information is significantly increased relative to, e.g., HEVC. Therefore, this disclosure recognizes that an efficient design for intra signaling is needed in VVC.

To have an efficient signaling, the design should take advantage of the usage statistics of the intra coding modes. Otherwise, it will result in costly signaling overhead. Moreover, it also increases the conditional checks during the derivation of the coding information. For example, if a mode with low probability is presented before other modes, the cost of signaling for this mode is included into the cost of higher probability modes; hence, the overhead increases.

Current intra mode signaling design of VVC may not comply with the statistics of the intra coding modes. For example, the probability that a block is encoded using non-zero reference index is quite small (˜5%). However, signaling of the reference index is placed before ISP and other regular intra modes that do not support non-zero reference index.

In addition, using DC or Planar as the default mode for intra DM chroma modes may not be efficient when the luma block is coded using PCM or IBC mode, or RDPCM (BDPCM), especially for screen contents where vertical and horizontal modes have better performance than the DC mode.

This disclosure describes various techniques that may improve the design of intra-prediction and intra mode coding. One or more techniques of this disclosure may be implemented separately or implemented together.

In some examples, video encoder 200 and video decoder 300 may code a value of a syntax element for a block of video data, the syntax element indicating whether the block is encoded using planar prediction mode with a reference index equal to zero, not being encoded using matrix intra-prediction (MIP) mode, and not being encoded using intra sub-partition coding (ISP) partitioning. That is, video encoder 200 and video decoder 300 may code a regular intra planar flag (reg_intra_planar_flag) in the bitstream. This flag may indicate whether a block is encoded using planar prediction mode with the reference index equal to zero and not being encoded using MIP nor ISP mode. If this flag is equal to 1, the signaling may be terminated (i.e., video encoder 200 and video decoder 300 may code no further bits to indicate intra mode for the block). The position of this flag may be based on the probability of the modes of the intra blocks.

In some examples, reg_intra_planar_flag may be placed before intra_luma_not_planar_flag. In this case, the intra_luma_not_planar_flag is only needed for ISP blocks, and the derivation condition of intra_luma_not_planar_flag may be changed as follows:

if( intra_subpartitions_mode_flag[ x0 ][ y0 ] = = 1 )

| | |
|---|---|
| intra_luma_not_planar_flag[ x0 ][ y0 ] | ae(v) |

In some examples, the reg_intra_planar_flag may be signalled before signaling of other flags such as bdpcm flag, mip flag, isp flag and reference index coding. In this case, the syntax structure of the mode signaling for the luma intra mode may be presented as follows, where text between double asterisks (**) indicates an addition relative to VVC:

Descriptor

coding_unit( x0, y0, cbWidth, cbHeight, treeType ) {
...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCbSizeY && cbHeight <=

MaxIpcmCbSizeY)

| | |
|---|---|
| pcm_flag[ x0 ][ y0 ] | ae(v) |

if( pcm_flag[ x0 ][ y0 ] ) {

while( !byte_aligned( ))

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

| | |
|---|---|
| **reg_intra_planar_flag[ x0 ][ y0 ] | ae(v) |
| if ( reg_intra_planar_flag[ x0 ][ y0 ] = = 0) {** | |

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

if( sps_mip_enabled_flag &&

( Abs( Log2( cbWidth ) − Log2( cbHeight ) ) <= 2 ) &&
cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_ _flag[ x0 ][ y0 ] | ae(v) |
| if( intra_mip_mpm_flag[ x0 ][ y0 ] ) | |

| | |
|---|---|
| intra_mip_mpm_idx[ x0 ][ y0 ] | ae(v) |

else

| | |
|---|---|
| intra_mip_mpm_remainder[ x0 ][ y0 ] | ae(v) |

} else {

if( sps_mrl_enabled_flag &&

( ( y0 % CtbSizeY ) > 0 ) )

| | |
|---|---|
| intra_luma_ref_idx[ x0 ][ y0 ] | ae(v) |

if ( sps_isp_enabled_flag &&

intra_luma_ref_idx[ x0 ][ y0 ] = = 0 &&

( cbWidth <= MaxTbSizeY && cbHeight <=

MaxTbSizeY ) &&

( cbWidth * cbHeight > MinTbSizeY * MinTbSizeY ) )

| | |
|---|---|
| intra_subpartitions_mode_flag[ x0 ][ y0 ] | ae(v) |

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |

if( intra_luma_ref_idx[ x0 ][ y0 ] = = 0 &&

| | |
|---|---|
| intra_subpartitions_mode_flag[ x0 ][ y0 ] = = 0 ) | |
| intra luma mpm_flag[ x0 ][ y0 ] | ae(v) |

if( intra_luma_mpm_flag[ x0 ][ y0 ] ) {

**if( intra_subpartitions_mode_flag[ x0 ][ y0 ] = = 1

)**

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}
**}**

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /* MODE_INTER

or MODE_IBC */
...

In the above syntax structure, if reg_intra_planar_flag[x0][y0]=1, the prediction mode of the block is planar with the following settings: intra_subpartitions_mode_flag[x0][y0]=0, intra_luma_ref_idx[x0][y0]=0, intra_mip_flag[x0][y0]=0, and intra_bdpcm_flag[x0][y0]=0. In some examples, when reg_intra_planar_flag[x0][y0] is equal to 1, the values of intra_subpartitions_mode_flag[x0][y0], intra_luma_ref_idx[x0][y0], intra_mip_flag[x0][y0], and intra_bdpcm_flag[x0][y0] are all inferred to be equal to 0.

When intra_subpartitions_mode_flag[x0][y0] is not equal to 1, the value of intra_luma_not_planar_flag[x0][y0] may not be signalled (i.e., not coded by video encoder 200 and video decoder 300), and may be inferred to be equal to 1.

In some examples, video encoder 200 and video decoder 300 may code a value of a syntax element for a block of video data, the syntax element indicating whether the block is encoded using a zero reference line index, not encoded using intra sub-partition coding (ISP) partitioning, not encoded using matrix intra-prediction (MIP) mode, and not encoded using blurred differential pulse code modulation (BDPCM) mode. That is, video encoder 200 and video decoder 300 may code a regular_intra_flag in the bitstream. This flag may indicate whether the block is encoded using zero reference line index, non-ISP partitioning, and non-MIP or non-BDPCM mode. When this flag is 1, explicit signaling of ISP information, BDPCM mode, MIP information and reference index may be no longer needed. The position of this flag relative to the other syntax elements related to intra mode signaling may be based on the probability of the modes of the intra blocks.

In some examples, video encoder 200 and video decoder 300 may code the regular_intra_flag before all other intra mode flags (e.g., MIP flag, ISP flag, and reference index signaling). In this case, the syntax structure of the mode signaling the luma intra mode may be presented as follows, where text surrounded by double asterisks (**) represents added text relative to VVC WD5 and text marked as [deleted: “ ”] is deleted relative to VVC WD5:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinlpcmCbSizeY && cbWidth <=

MaxIpcmCbSizeY &&

cbHeight >= MinIpcmCbSizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ))

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

| | |
|---|---|
| **regular_intra_flag[ x0 ][ y0 ] | ae(v) |

// Note: if regular_intra_flag value is equal to 1, then the values of
intra_mip_flag, intra_luma_ref_idx, intra_subpartitions_mode_flag are
inferred to be equal to 0

if ( regular_intra_flag[ x0][y0] = = 0) {**

if( sps_mip_enabled_flag &&

( Abs( Log2( cbWidth ) − Log2( cbHeight) ) <= 2 )

&&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

else

| | |
|---|---|
| intra_mip_mpm_remainder[ x0 ][ y0 ] | ae(v) |

} else {

if( sps_mrl_enabled_flag &&

( ( y0 % CtbSizeY ) > 0 ) )

| | |
|---|---|
| intra_luma_ref_idx[ x0 ][ y0 ] | ae(v) |

if ( sps_isp_enabled_flag &&

intra_luma_ref_idx[ x0 ][ y0 ] = = 0 [deleted: “&&

( cbWidth <= MaxTbSizeY && cbHeight <=

MaxTbSizeY ) &&

( cbWidth * cbHeight >

MinTbSizeY * MinTbSizeY )”] )

| | |
|---|---|
| [deleted: | ae(v)”] |

“intra_subpartitions_mode_flag[ x0 ][ y0 ]
Note: if above condition is true, then of intra_subpartitions_mode_flag
is not signalled and the value of intra_subpartitions_mode_flag is
inferred to be equal to 1: intra_subpartitions_mode_flag[ x0 ][ y0 ] = 1
Note2: examples of normative conditions for having
intra_subpartitions_mode_flag[ x0 ][ y0 ] equal to 1 : ( cbWidth <=
MaxTbSizeY && cbHeight <= MaxTbSizeY ) && (
cbWidth * cbHeight > MinTbSizeY * MinTbSizeY )
Otherwise, the value of intra_luma_ref_idx is not allowed to be equal
to 0, for example, only non-zero reference line numbers (1, 3) are
signalled

if( intra_subpartitions_mode_flag[ x0 ][ y0 ] = = 1 &&

cbWidth <= MaxTbSizeY && cbHeight <=

MaxTbSizeY )

| | |
|---|---|
| intra subpartitions split flag[ x0 ][ y0 ] | ae(v) |

**}**

**}**
**if( intra_mip_flag = = 0 ) {**
if( intra_luma_ref_idx[ x0 ][ y0 ] = = 0 &&

| | |
|---|---|
| intra_subpartitions_mode_flag[ x0 ][ y0 ] = = 0 ) | |
| intra_luma_mpm_flag[ x0 ][ y0 ] | ae(v) |

**Note: intra_luma_mpm_flag is inferred equal to 1, if not present**

if( intra_luma_mpm_flag[ x0 ][ y0 ] ) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /*

MODE_INTER or MODE_IBC */
...

In another example, video encoder 200 and video decoder 300 may code the ISP flag before the reference index. In this case, the syntax structure of the mode signaling the luma intra mode may be presented as follows, where text surrounded by double asterisks (**) represents added text relative to VVC WD5 and text marked as [deleted: “ ”] is deleted relative to VVC WD5:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCbSizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ) )

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

| | |
|---|---|
| **regular_intra_flag[ x0 ][ y0 ] | ae(v) |

Note: if regular_intra_flag value is equal to 1, then the values of
intra_mip_flag, intra_luma_ref_idx, intra_subpartitions_mode_flag are
inferred equal to 0

if ( regular_intra_flag[ x0 ][ y0 ] = = 0 ) {**

if( sps_mip_enabled_flag &&

( Abs( Log2( cbWidth ) − Log2( cbHeight ) ) <= 2 ) &&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

else

| | |
|---|---|
| intra_mip_mpm_remainder[ x0 ][ y0 ] | ae(v) |

} else {

[deleted: “if( sps_mrl_enabled_flag &&

( ( y0% CtbSizeY ) > 0 ) )

| | |
|---|---|
| intra_luma_ref_idx[ x0 ][ y0 ] | ae(v)”] |

if ( sps_isp_enabled_flag && [deleted:

“intra_luma_ref_idx[ x0 ][ y0 ] = = 0 &&”]

( cbWidth <= MaxTbSizeY && cbHeight <=

MaxTbSizeY ) &&

( cbWidth * cbHeight > MinTbSizeY * MinTbSizeY )

)

| | |
|---|---|
| intra_subpartitions_mode_flag[ x0 ][ y0 ] | ae(v) |

**Note: if above condition is false, then the value of
intra_subpartitions_mode_flag is inferred equal to 0; and if
intra_subpartitions_mode_flag is equal to 1, then intra_luma_ref_idx is
inferred equal to 0
Note2: The condition to signal the intra_subpartitions_mode flag may
include a check for top boundary of the CTU as follows (green
highlight):
( sps_isp_enabled_flag && ( ( y0 % CtbSizeY ) > 0 ) && ( cbWidth
<= MaxTbSizeY && cbHeight <= MaxTbSizeY ) && (
cbWidth * cbHeight > MinTbSizeY * MinTbSizeY ) )
If the condition is false, then the intra_subpartitions_mode_flag is not
signalled and its value is inferred equal to 1, because intra_luma_ref_idx
can not be non-zero in this case**

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |

**if( sps_mrl_enabled_flag &&

( ( y0% CtbSizeY ) > 0 ) &&

intra_subpartitions_mode_flag[ x0 ][ y0 ] = = 0 )
intra_luma_ref_idx[ x0 ][ y0 ]

Note: signaling of intra_luma_ref_idx excludes the value 0, because the
value 0 can be inferred for regular and isp intra modes; if
intra_luma_ref_idx is not signalled then the value 0 is inferred

}

}
if( intra_mip_flag = = 0 ) {**

if( intra_luma_ref_idx[ x0 ][ y0 ] = = 0 &&

| | |
|---|---|
| intra_subpartitions_mode_flag[ x0 ][ y0 ] = = 0 ) | |
| intra_luma_mpm_flag[ x0 ][ y0 ] | ae(v) |

**Note: intra_luma_mpm_flag is inferred equal to 1, if not present**

if( intra_luma_mpm_flag[ x0 ][ y0 ] ) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /* MODE_INTER

or MODE_IBC */
...

The following syntax structure represents an alternative to the syntax structure above:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCbSizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ))

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

| | |
|---|---|
| **regular_intra_flag[ x0 ][ y0 ] | ae(v)** |
| if( **regular_intra_flag[ x0 ][ y0 ] = = 0 &&** | |

sps_mip_enabled_flag &&

( Abs( Log2( cbWidth ) − Log2( cbHeight) ) <= 2 ) &&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

else

| | |
|---|---|
| intra_mip_mpm_remainder[ x0 ][ y0 ] | ae(v) |

} else {

[deleted: “if( sps_mrl_enabled_flag &&

( ( y0 % CtbSizeY ) > 0 ) && regular_intra_flag[x0][y0]
= = 0)

| | |
|---|---|
| intra_luma_ref_idx[ x0 ][ y0 ] | ae(v)”] |

if ( sps_isp_enabled_flag [deleted: “&&

intra_luma_ref_idx[ x0 ][ y0 ] = = 0”] &&

( cbWidth <= MaxTbSizeY && cbHeight <=

MaxTbSizeY ) &&

( cbWidth * cbHeight > MinTbSizeY * MinTbSizeY )

**&&

| | |
|---|---|
| regular_intra_flag[ x0 ][ y0 ] = = 0** ) | |
| intra_subpartitions_mode_flag[ x0 ][ y0 ] | ae(v) |

**Note: if above condition is false, then the value of
intra_subpartitions_mode_flag is inferred equal to 0**

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |

if( sps_mrl_enabled_flag && ( ( y0 % CtbSizeY ) > 0 )

**&&

regular_intra_flag[ x0 ][ y0 ] = = 0 &&

intra_subpartitions_mode_flag[ x0 ][ y0 ] = = 0**)

| | |
|---|---|
| intra_luma_ref_idx[ x0 ][ y0 ] | ae(v) |

**Note: signaling of intra_luma_ref_idx excludes the value 0, because
the value 0 can be inferred for regular and ISP intra modes; if
intra_luma_ref_idx is not signalled, then the value 0 is inferred**

if( intra_luma_ref_idx[ x0 ][ y0 ] = = 0 &&

| | |
|---|---|
| intra_subpartitions_mode_flag[ x0 ][ y0 ] = = 0 ) | |
| intra_luma_mpm _flag[ x0 ][ y0 ] | ae(v) |

**Note: intra_luma_mpm_flag is inferred equal to 1, if not present**

if( intra_luma_mpm_flag[ x0 ][ y0 ] ) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /* MODE_INTER

or MODE_IBC */
...

Video encoder 200 and video decoder 300 may entropy code the regular_intra_flag using bypass coding or with one or multiple contexts. The contexts may be dependent on data from one or more neighbouring blocks, such as the value of the regular_intra_flag of neighbouring blocks, or whether one or more neighouring blocks are coded with an intra mode versus inter mode or IBC. The neighbouring block positions may be on the left or top of the current block, either located near the top-left corner of the current block or located near the top-right corner or bottom-left corner of the current block. There may be a restriction added to disallow accessing a block on top of the current block if the current block is located at the top of the coding tree block.

In some examples, video encoder 200 and video decoder 300 may code the context of encoding regular_intra_flag dependent on the size of the current block. In an example, the number of the contexts may be 4 and the indices (ranged from 0 to 3) may be defined as follows:

contextIdx=Min[3,(log 2(width)+log 2(height)−offset)/2)

where offset=log 2(min_block_luma_width)+log 2(min_block_luma_height) width and height are the width and height of the block in luma samples, respectively.

In the current VVC WD5, min_block_luma_width and min_block_luma_height are set equal to 4.

In another example, video encoder 200 and video decoder 300 may determine a context for coding regular_intra_flag according to a slice type of a current slice. For example, the number of contexts may be 3 with indices (ranging from 0 to 2, inclusive) that may be defined as: contextIdx=slice_type==I_SLICE?0:(slice_type==B_SLICE?1:2). That is, if the slice is an I-slice (intra-coded slice), then video encoder 200 and video decoder 300 may select the context index of 0. If the slice is a B-slice (a slice allowing for bi-directional prediction), then video encoder 200 and video decoder 300 may select the context index of 1. Otherwise, if the slice is a P-slice (a slice allowing for uni-directional prediction), then video encoder 200 and video decoder 300 may select the context index of 2.

In another example, the number of contexts may be 2 with indices (ranging from 0 to 1, inclusive), that may be defined as: contextIdx=slice_type==I_SLICE?0:1. That is, if the slice is an I-slice (intra-coded slice), then video encoder 200 and video decoder 300 may select the context index of 0. Otherwise (e.g., for both P- and B-slices), video encoder 200 and video decoder 300 may select the context index of 1.

In some examples, the coding of the regular_intra_flag by video encoder 200 and video decoder 300 may be dependent on the signaling of a high-level flag, such as regular_intra_flag_present, for example, in the sequence parameter set (SPS), picture parameter set (PPS), video parameter set (VPS), or other parameter set, slice header, tile header, brick header, etc. In some examples, if the regular_intra_flag_present flag is equal to 0, the value of the regular_intra_flag is inferred to be equal to 1 and the values of other mode flags, such as MIP, ISP, reference line index, etc. are inferred to be equal to 0. In this case, only regular intra modes are allowed.

In some examples, the intra_luma_ref_idx signaling may be needed when intra_subpartitions_mode_flag[x0][y0]=0. Therefore, the condition check for signaling may be changed as:

if( [deleted: “sps_mrl_enabled_flag &&

( ( y0 % CtbSizeY ) > 0 ) && regular_intra_flag[x0][y0]
= = 0 &&”] **intra_subpartitions_mode_flag[ x0 ][ y0 ] = = 0**)

| | |
|---|---|
| intra_luma_ref_idx[ x0 ][ y0 ] | ae(v) |

In addition, the signaling for zero reference index may be not needed. Therefore, only non-zero reference index may need to be signalled. For example, in WD5, the reference index can be 0, 1, or 3. In this case, only one bit needs to be signalled to indicate the reference index is 1 or 3.

In some examples, video encoder 200 and video decoder 300 may code both reg_intra_planar_flag and regular_intra_flag that were discussed above in the bitstream. In some examples, reg_intra_planar_flag may be placed before regular_intra_flag in the bitstream for the same block.

In some examples, video encoder 200 and video decoder 300 may code a value of a syntax element for a block of video data, the syntax element indicating whether the block is encoded using a regular intra mode of a most probable mode (MPM) list and not using pulse code modulation (PCM), intra sub-partition coding (ISP) partitioning, multiple reference line (MRL) prediction mode, and blurred differential pulse code modulation (BDPCM) mode. That is, video encoder 200 and video decoder 300 may code a value for a reg_mpm_flag, which may indicate whether the block is regular intra mode (non-PCM, non-ISP, mrl_index=0, non-BDPCM) with an MPM prediction mode (a mode in the MPM list).

In some examples, reg_mpm_flag may be signalled before signaling of other modes. Notice that intra_luma_mpm_flag may not need to be signalled. The syntax structure of the mode signaling the luma intra mode may be presented as follows:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCbSizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ) )

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

| | |
|---|---|
| **reg_mpm_flag[x0][y0] | ae(v) |
| if (reg_mpm_flag[x0[y0] == 0) {** | |
| if( sps_mip_enabled_flag && | |

( Abs( Log2( cbWidth ) − Log2( cbHeight ) ) <= 2 ) &&
cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

Else

| | |
|---|---|
| intra_mip_mpm_remainder[ x0 ][ y0 ] | ae(v) |

} else {
if( sps_mrl_enabled_flag && ( (y0 % CtbSizeY ) > 0 )

)

| | |
|---|---|
| intra_luma_ref_idx[ x0 ][ y0 ] | ae(v) |

if ( sps_isp_enabled_flag &&

intra_luma_ref_idx[ x0 ][ y0 ] = = 0 &&

( cbWidth <= MaxTbSizeY && cbHeight <=

MaxTbSizeY ) &&

| | |
|---|---|
| ( cbWidth * cbHeight > MinTbSizeY * MinTbSizeY ) ) | |
| intra_subpartitions_mode_flag[ x0 ][ y0 ] | ae(v) |

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |
| ** } | |

}**
[deleted: “if( intra_luma_ref_idx[ x0 ][ y0 ] = = 0 &&

| | |
|---|---|
| intra_subpartitions_mode_flag[ x0 ][ y0 ] = = 0 ) | |
| intra_luma_mpm_flag[ x0 ][ y0 ] | ae(v)”] |

**if ( intra_mip_flag[x0][y0] = = 0 ) {**
if( [deleted: “intra_luma_mpm_flag[ x0 ][ y0 ]”]

**reg mpm flag[x0][y0] = = 1 ||
intra_subpartitions_mode_flag[ x0 ][ y0 ] != 0 ||
intra_luma_ref_idx[ x0 ][ y0 ] != 0**) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /*

MODE_INTER or MODE_IBC */
...

In the above syntax structure, if reg_mpm_flag[x0][y0]=1, the prediction mode of the block is regular intra block with a MPM prediction mode. In other words, intra_luma_mpm_flag of this block is inferred as 1, and intra_subpartitions_mode_flag[x0][y0]=0, intra_luma_ref_idx[x0][y0]=0, intra_mip_flag[x0][y0]=0, intra_bdpcm_flag[x0][y0]=0.

In some examples, intra_luma_mpm_flag may be signalled together with reg_mpm_flag. In some examples, this flag may be coded by video encoder 200 and video decoder 300 if intra_luma_mpm_flag may[x0][y0] is equal to 0. The position of this flag may be right after the intra_luma_mpm_flag and before the mip flag, before the signaling of MRL index. When reg_mpm_flag[x0][y0] is equal to 1, the signaling of other mode may be terminated. Otherwise, the MIP and MRL of the block is signalled. In also this example, intra_subpartitions_mode_flag may not need to be signalled. The syntax structure of the mode signaling the luma intra mode may be presented as follows:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCb SizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ))

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

| | |
|---|---|
| **reg_mpm_flag[x0][y0] | ae(v) |

Note that: When reg_mpm_flag[x0][y0] == 1,
intra_luma_mpm_flag[ x0 ][ y0 ] is inferred as 0.

| | |
|---|---|
| if (reg_mpm_flag[x0][y0] == 0) { | |
| intra_luma_mpm_flag[ x0 ][ y0 ] | ae(v) |

if (intra_luma_mpm_flag[ x0 ][ y0 ] == 0) {**

if( sps_mip_enabled_flag &&

( Abs( Log2( cbWidth ) − Log2( cbHeight ) ) <= 2 )

&&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

Else

| | |
|---|---|
| intra_mip_mpm_remainder[ x0 ][ y0 ] | ae(v) |

} else {

if( sps_mrl_enabled_flag &&

( ( y0 % CtbSizeY ) > 0 ) )

| | |
|---|---|
| intra_luma_ref_idx[ x0 ][ y0 ] | ae(v) |

if ( sps_isp_enabled_flag &&

intra_luma_ref_idx[ x0 ][ y0 ] = = 0 [deleted: “&&

( cbWidth <= MaxTbSizeY && cbHeight <=

MaxTbSizeY ) &&

( cbWidth * cbHeight >

MinTbSizeY * MinTbSizeY )”] )
**Note that: This is a normative condition, when this condition is true,
the intra_subpartitions_mode_flag[ x0 ][ y0 ] is inferred as 1. The
signaling of this flag is non logner need.**

| | |
|---|---|
| [deleted: “intra_subpartitions_mode_flag[ x0 ][ y0 ] | ae(v)”] |

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |
| ** } | |

}**

[deleted: “if( intra_luma_ref_idx_[ x0 ][ y0 ] = = 0 &&

| | |
|---|---|
| intra_subpartitions_mode_flag[ x0 ][ y0 ] = = 0 ) | |
| intra_luma_mpm_flag[ x0 ][ y0 ] | ae(v)”] |
| **if ( intra_mip_flag[x0][y0] = = 0 ) {** | |

if( [deleted: “intra_luma_mpm_flag[ x0 ][ y0 ]”]

**reg_mpm_flag[x0][y0] == 1 ||
intra_subpartitions_mode_flag[ x0 ][ y0 ] != 0 ||
intra_luma_ref_idx[ x0 ][ y0 ] != 0**) {

if( intra_luma_ref_idx_[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}

}
if( treeType = = SINGLE_TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /*

MODE_INTER or MODE_IBC */
...

In some examples, video encoder 200 and video decoder 300 may code the reg_mpm_flag after the intra_mip_flag in the bitstream. The signalling mechanism may be as follows, where text between double asterisks (**) indicates an addition relative to VVC WD5:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinlpcmCb SizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ))

| | |
|---|---|
| pcm_alignment_zero_bit | f(1) |

pcm_sample( cbWidth, cbHeight, treeType)

} else {

if( treeType = = SINGLE_TREE | | treeType = =

DUAL_TREE_LUMA ) {

if( cbWidth <= 32 && cbHeight <= 32 )

| | |
|---|---|
| intra_bdpcm_flag[ x0 ][ y0 ] | ae(v) |

if( intra_bdpcm _flag[ x0 ][ y0 ] )

| | |
|---|---|
| intra_bdpcm_dir_flag [ x0 ][ y0 ] | ae(v) |

else {

if( sps_mip_enabled_flag &&

( Abs( Log2( cbWidth ) − Log2( cbHeight) ) <= 2 ) &&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

Else

| | |
|---|---|
| intra_mip_mpm_remainder[ x0 ][ y0 ] | ae(v) |

} else {

**reg_mpm_flag[x0][y0]
If (reg_mpm_flag[x0][y0] == 0){**

if( sps_mrl_enabled_flag && ( ( y0% CtbSizeY ) > 0 ) )

| | |
|---|---|
| intra_luma_ref_idx[ x0 ][ y0 ] | ae(v) |

if (sps_isp_enabled_flag &&

intra_luma_ref_idx[ x0 ][ y0 ] = = 0 &&

( cbWidth <= MaxTbSizeY && cbHeight <=

MaxTbSizeY ) &&

| | |
|---|---|
| ( cbWidth * cbHeight > MinTbSizeY * MinTbSizeY ) ) | |
| intra_subpartitions_mode_flag[ x0 ][ y0 ] | ae(v) |

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |

| [symbol] | | |
|---|---|---|
| [symbol] | | |
| [symbol] | | ae(v) |
| | **} | ** |

if(

[symbol]

**reg_mpm_flag[x0][y0] == 1 || intra_luma_ref_idx[ x0 ][ y0 ] > 0 ||
intra_subpartitions_mode_flag[ x0 ][ y0 ] != 0**) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}

}
if( treeType = = SINGLE TREE | | treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /* MODE_INTER

or MODE_IBC */
...

In some examples, video encoder 200 and video decoder 300 may code a value of a syntax element for a block of video data, the syntax element indicating a type of intra mode coding used for the block and a value of a syntax element indicating whether a most probable mode (MPM) list is used to determine an intra mode for the block. When the value of the syntax element indicating whether the MPM list is used indicates that the MPM list is used, video encoder 200 and video decoder 300 may code a value for a syntax element indicating an MPM index into the MPM list for the block. When the value of the syntax element indicating whether the MPM list is used indicates that the MPM list is not used, video encoder 200 and video decoder 300 may code a value for a syntax element indicating an MPM remainder for the block. That is, video encoder 200 may code an intra_mode_coding_type indicating the type of intra mode coding that is used, followed by an mpm_flag, mpm_idx and remaining mode. These techniques may simplify the signaling of intra mode coding and provide an easy way to identify various intra-prediction methods.

Currently, there are five different types of intra mode coding specified: regular, matrix-based, intra sub-partitions, multiple reference lines, and BDPCM. For some modes, only an mpm_idx is signalled, whereas other modes may indicate the particular mode with mpm_idx or remaining mode. In some examples, the signaling mechanism used by video encoder 200 and video decoder 300 may be as follows:

Descriptor

coding_unit( x0, y0, cbWidth, cbHeight, treeType ) {

if( slice_type != I | | sps_ibc_enabled_flag ) {

...

}
if( CuPredMode[ x0 ][ y0 ] = = MODE_INTRA ) {

if( sps_pcm_enabled_flag &&

cbWidth >= MinIpcmCbSizeY && cbWidth <=

MaxIpcmCbSizeY &&

cbHeight >= MinIpcmCb SizeY && cbHeight <=

MaxIpcmCbSizeY )

| | |
|---|---|
| pcm_flag[ x0 ][ y0 ] | ae(v) |

if( pcm_flag[ x0 ][ y0 ] ) {

while( !byte_aligned( ) )

| | |
|---|---|
| pcm_alignment_zero_bit | f(1) |

pcm_sample( cbWidth, cbHeight, treeType)

} else {

**if( treeType = = SINGLE TREE | | treeType = =

DUAL_TREE_LUMA ) {

| | |
|---|---|
| intra_mode_coding_type[ x0 ][ y0 ] | ae(v) |
| if( intra_mode_coding_type[ x0 ][ y0 ] <= 1) | |

| | |
|---|---|
| intra_mode_mpm_flag[ x0 ][ y0 ] | ae(v) |

if( intra_mode_mpm_flag[ x0 ][ y0 ] )

| | |
|---|---|
| intra_mode_mpm_idx[ x0 ][ y0 ] | ae(v) |

else

| | |
|---|---|
| intra_mode_mpm_remainder[ x0 ][ y0 ] | ae(v)** |

[deleted: “if( cbWidth <= 32 && cbHeight <= 32 )

| | |
|---|---|
| intra_bdpcm_flag[ x0 ][ y0 ] | ae(v) |

if( intra_bdpcm_flag[ x0 ][ y0 ] )

| | |
|---|---|
| intra_bdpcm_dir_flag [ x0 ][ y0 ] | ae(v) |

else {

if( sps_mip_enabled_flag &&

( Abs( Log2( cbWidth ) − Log2( cbHeight) ) <= 2 ) &&

cbWidth <= MaxTbSizeY && cbHeight <=

MaxTbSizeY )

| | |
|---|---|
| intra_mip_flag[ x0 ][ y0 ] | ae(v) |

if( intra_mip_flag[ x0 ][ y0 ] ) {

| | |
|---|---|
| intra_mip_mpm_flag[ x0 ][ y0 ] | ae(v) |

if( intra_mip_mpm_flag[ x0 ][ y0 ] )

| | |
|---|---|
| intra_mip_mpm_idx[ x0 ][ y0 ] | ae(v) |

Else

| | |
|---|---|
| intra_mip_mpm_remainder[ x0 ][ y0 ] | ae(v) |

} else {

if( sps_mrl_enabled_flag && ( ( y0 % CtbSizeY ) > 0 )

)

| | |
|---|---|
| intra_luma_ref_idx[ x0 ][ y0 ] | ae(v) |

if (sps_isp_enabled_flag &&

intra_luma_ref_idx[ x0 ][ y0 ] = = 0 &&

( cbWidth <= MaxTbSizeY && cbHeight <=

MaxTbSizeY ) &&

| | |
|---|---|
| ( cbWidth * cbHeight > MinTbSizeY * MinTbSizeY ) ) | |
| intra_subpartitions_mode_flag[ x0 ][ y0 ] | ae(v) |

if( intra_subpartitions_mode_flag[ x0 ][ y0 ] = = 1 &&

cbWidth <= MaxTbSizeY && cbHeight <=

MaxTbSizeY )

| | |
|---|---|
| intra_subpartitions_split_flag[ x0 ][ y0 ] | ae(v) |

if( intra_luma_ref_idx[ x0 ][ y0 ] = = 0 &&

| | |
|---|---|
| intra_subpartitions_mode_flag[ x0 ][ y0 ] = = 0 ) | |
| intra_luma_mpm_flag[ x0 ][ y0 ] | ae(v) |

if( intra_luma_mpm_flag[ x0 ][ y0 ] ) {

if( intra_luma_ref_idx[ x0 ][ y0 ] = = 0 )

| | |
|---|---|
| intra_luma_not_planar_flag[ x0 ][ y0 ] | ae(v) |

if( intra_luma_not_planar_flag[ x0 ][ y0 ] )

| | |
|---|---|
| intra_luma_mpm_idx[ x0 ][ y0 ] | ae(v) |

} else

| | |
|---|---|
| intra_luma_mpm_remainder[ x0 ][ y0 ] | ae(v) |

}

}”]

}
if( treeType = = SINGLE_TREE treeType = =

DUAL_TREE_CHROMA )

| | |
|---|---|
| intra_chroma_pred_mode[ x0 ][ y0 ] | ae(v) |

}

} else if( treeType != DUAL_TREE_CHROMA ) { /*

MODE_INTER or MODE_IBC */
...

The semantics of the syntax elements in this example may be as follows:

intra_mode_coding_type[x0][y0] specifies the intra-prediction method used to generate the prediction for the current block. The value of intra_mode_coding_type[x0][y0] shall be in the range of 0 to 4, inclusive. The prediction modes for various values of intra_mode_coding_type[x0][y0] are specified in Table 3 below.

TABLE 3

| | Intra | | | MaxNumRemain- |
|---|---|---|---|---|
| intramode_coding_type[ | Coding | intra_mpm_flag[ | MaxMPMListSize[intra_mode_coding | ingModes[in- |
| ][ ] | Method | ][ ] | type[ [ ]] | tra_mode_coding_type[x0][y0] ] |
| 0 | INTRA_REGULAR | 0 or 1 | 6 | 61 |
| 1 | INTRA_MIP | 0 or 1 | 3 | May depend on |
| | | | | block size e.g., |
| | | | | (cbWidth = = 4 |
| | | | | && cbHeight = = 4)? |
| | | | | 32:((cbWidth <= 8 |
| | | | | && cbHeight <= 8)? |
| | | | | 16:8) |
| 2 | INTRA_ISP | 1 | 6 | May depend on |
| | | | | conditions, e.g., |
| | | | | (cbWidth <= MaxTbSizeY |
| | | | | && cbHeight <= MaxTbSizeY) |
| | | | | && (cbWidth * cbHeight > |
| | | | | MinTbSizeY * |
| | | | | MinTbSizeY) |
| 3 | INTRA_MRL | 1 | 5 | May depend on |
| | | | | conditions, e.g., |
| | | | | not allowed if |
| | | | | block located at |
| | | | | top of coding tree |
| | | | | unit: |
| | | | | (y0% CtbSizeY) > 0) |
| 4 | INTRA_BDPCM | 1 | 2 | — |

In some examples, the intra_mode_coding_type[ ][ ] may be coded using truncated unary. Some restrictions may be applied on the allowed values of intra_mode_coding_type[ ][ ] based on the value of other syntax elements in the bitstream. For example, when a particular coding method is not allowed for a particular block, the value of intra_mode_coding_type[ ][ ] is disallowed to take the particular value. For example, when the top boundary of the current block shares the CTU boundary, intra_mode_coding_type[ ][ ] may be disallowed to be equal to 3 (no multiple reference lines). Similar restrictions may be applied on other coding methods based on block size, intra mode method/types or other characteristics of current and neighbouring blocks.

In some examples, intra_mode_coding_type[ ] may be generated from a dynamic list for a particular coded video sequence based on the values of some syntax elements in the bitstream or in the parameter sets (e.g., SPS). For example, when SPS control flags for various intra coding methods indicate one or more methods may not be applied for the current block, these modes may not be included in the intra mode methods available for the current block and the value of intra_mode_coding_type[ ][ ] may be constrained so that codewords are not wasted to signal unavailable modes.

intra_mpm_flag[x0][y0] equal to 1 specifies that the intra-prediction mode used is specified using the syntax element intra_mpm_idx[x0][y0]. intra_mpm_flag[x0][y0] equal to 0 specifies that the intra-prediction mode used is specified using the syntax element intra_mpm_idx[x0][y0]. When not present, the value of intra_mpm_flag[x0][y0] is inferred to be equal to 1.

intra_mpm_idx[x0][y0] species the index to the mode in MPMList[intra_mode_coding_type[x0][y0] ] that is used for intra-prediction. The value of intra_mpm_idx[x0][y0] shall be in the range of 0 to MaxMPMListSize−1, inclusive. When not present, the value of intra_mpm_idx[x0][y0] is inferred to be equal to 1.

In the above semantics, the value of MaxMPMListSize specifies a maximum size of any MPMList[i]. The value may be a fixed value, e.g., 6.

In some examples, the value of intra_mpm_idx[x0][y0] is constrained to be in the range of 0 to MaxMPMListSize[intra_mode_coding_type[x0][y0]]−1, inclusive. Here, MaxMPMListSize[intra_mode_coding_type[x0][y0] ] specifies the maximum size of MPMList[intra_mode_coding_type[x0][y0]].

intra_mpm_remainder[x0][y0] specifies the intra mode used for the prediction when intra_mpm_flag is equal to 0. The value of intra_mpm_remainder[x0][y0] may be in the range of 0 to MaxNumRemainingModes−1, inclusive.

In some examples, the value of intra_mpm_remainder[x0][y0] shall be in the range of 0 to MaxNumRemainingModes[intra_mode_coding_type[x0][y0]]−1, inclusive.

In some examples MaxMPMListSize may be set equal to maximum value of MaxMPMListSize[i] for all i.

The syntax element intra_mpm_idx[ ][ ] may be coded as a truncated coded syntax element with values in the range of 0 to MaxMPMListSize−1, inclusive. For intra coding methods where MaxMPMListSize[intra_mode_coding_type[ ][ ]] is less than MaxMPMListSize, the value of intra_mpm_idx[ ][ ] may be clipped to be in the range of 0 to MaxMPMListSize[intra_mode_coding_type[x0][y0]]−1, inclusive.

The syntax element intra_mpm_remainder[ ][ ] may be coded using fixed length or truncated binary coding. The number of bits, or the maximum value of the syntax element may be determined based on the value of MaxNumRemainingModes[intra_mode_coding_type[x0][y0] ].

The four syntax elements may be coded using contexts, and these contexts may be dependent on other syntax elements in the bitstream, or on block characteristics or intra mode types of current and neighbouring blocks. E.g., intra_mpm_flag[ ] may be coded using one context for each value of intra_mode_coding_type.

In some examples, some additional signaling may be needed for certain prediction modes and these would be indicated separately. For example, when the prediction mode method is INTRA_ISP, a split flag (indicating horizontal or vertical split) may be signalled as follows:

| ... | | ae(v) |
|---|---|---|
| if( intra_mode_coding_type[ x0 ][ y0 ] = = INTRA_ISP ) | | |
| | isp_split_flag[ x0 ][ y0 ] | ae(v) |

...

Additionally, in some examples, video encoder 200 and video decoder 300 may code an intra_planar_flag for one or more of the intra mode types specifying that a planar prediction is used for the coding block.

In some examples, video encoder 200 and video decoder 300 may be configured to derive an intra-prediction mode for a chroma block coded using chroma direct mode (DM) when a corresponding luma block is coded using PCM or IBC. That is, when the chroma block is encoded using DM mode and the corresponding luma block is encoded using either IBC or PCM mode, video encoder 200 and video decoder 300 may derive the prediction mode for the chroma block as being equal to a default mode that has a high probability of occurring. In some examples, the default mode may be one of the prediction modes enabled for chroma. In some examples, the default mode may be set equal to planar mode. In some examples, if the corresponding luma block is predicted using IBC, the default mode may be a vertical prediction mode (e.g., VER_IDX in VVC WD5). In some examples, if the corresponding luma block is predicted using IBC, the default mode may be a horizontal prediction mode (e.g., HOR_IDX in VVC WD5). In some examples, if the corresponding luma block is predicted using PCM, the default mode may be planar prediction mode. In some examples, the default mode may be one of a variety of complexity classification using machine learning (CCML) modes.

In some examples, when the chroma block is encoded using DM mode and the corresponding luma block is encoded using RDPCM (or BDPCM), video encoder 200 and video decoder 300 may determine the prediction mode of the chroma block based on the prediction mode of the corresponding luma block. In one example, if the RDPCM luma block is vertical prediction, the prediction mode of the chroma block is set equal to vertical prediction. In another example, if the RDPCM luma block is horizontal prediction, the prediction mode of the chroma block may be set equal to horizontal prediction.

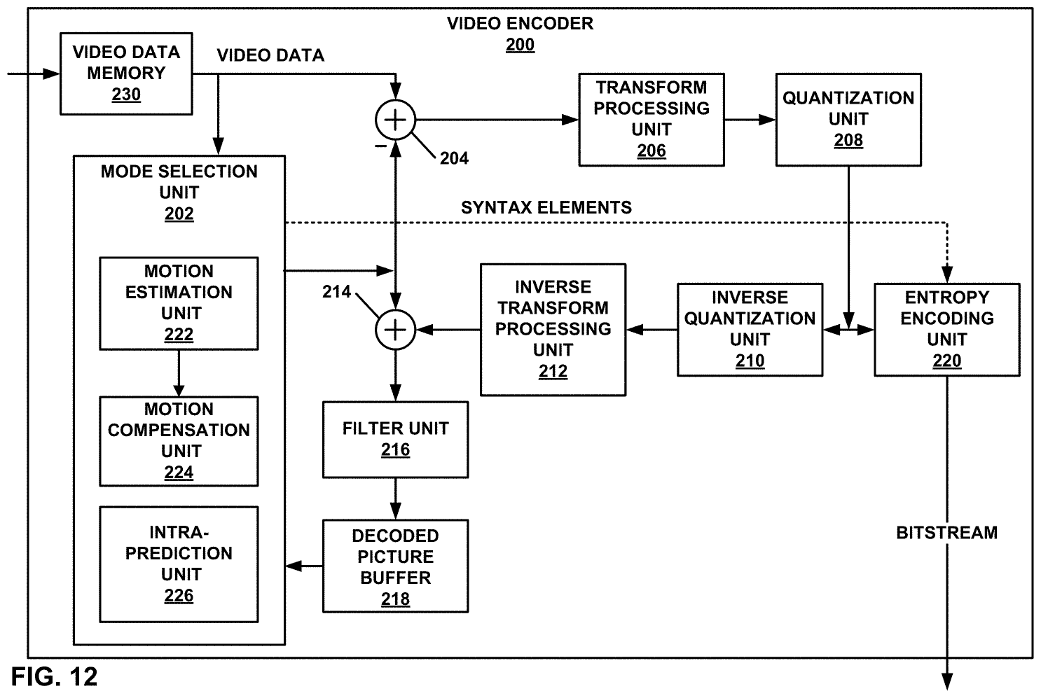

FIG. 12 is a block diagram illustrating an example video encoder 200 that may perform the techniques of this disclosure. FIG. 12 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards, and are applicable generally to video encoding and decoding.

In the example of FIG. 12, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 12 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

In accordance with the techniques of this disclosure, mode selection unit 202 may select an intra-prediction mode from available intra-prediction modes, e.g., using RDO techniques. The selected intra-prediction mode may be a regular intra-prediction mode or a non-regular intra-prediction mode. The regular intra-prediction modes may include directional modes, DC mode, and planar mode. The non-regular intra-prediction modes may include other modes, such as ISP mode, MIP mode, and BDPCM mode, or other intra-prediction modes beyond directional modes, DC mode, and planar mode.

Mode selection unit 202 may provide an indication of the intra-prediction mode to entropy encoding unit 220. Entropy encoding unit 220 may, according to the techniques of this disclosure, entropy encode data representative of the intra-prediction mode used to predict the current block. For example, entropy encoding unit 220 may entropy encode a value for a syntax element indicating whether a regular intra-prediction mode is used to predict the block. The syntax element may be, for example, regular_intra_flag as discussed above. As noted above, regular_intra_flag may be entropy encoded before other non-regular intra mode flags, e.g., MIP flag, ISP flag, and reference index signaling. Additionally, entropy encoding unit 220 may entropy encode data of a high level syntax element, such as a syntax element of an SPS, indicating whether the regular_intra_flag syntax element is present in the block syntax structure.

Furthermore, as discussed above, entropy encoding unit 220 may, when the current block is predicted using a regular intra-prediction mode, avoid entropy encoding syntax elements for other non-regular intra-prediction modes, e.g., MIP, ISP, BDPCM, or the like. That is, entropy encoding unit 220 may entirely skip encoding of syntax elements for non-regular entropy encoding modes. Furthermore, entropy encoding unit 220 may entropy encode an indication of the regular intra-prediction mode using, e.g., an indication of whether the regular intra-prediction mode is included in an MPM list, and either an index into the MPM list or an MPM remainder accordingly. If instead the current block is predicted using a non-regular intra-prediction mode, entropy encoding unit 220 may entropy encode one or more of the non-regular intra-prediction syntax elements.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra-prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Entropy encoding unit 220 may entropy encode intra-prediction mode information according to any of the various techniques of this disclosure, as discussed above.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

In this manner, video encoder 200 represents an example of a device for coding video data including a memory configured to store video data; and one or more processors implemented in circuitry and configured to: code a value of a syntax element for a block of the video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; form a prediction block for the block according to the value of the syntax element; and code the block using the prediction block.

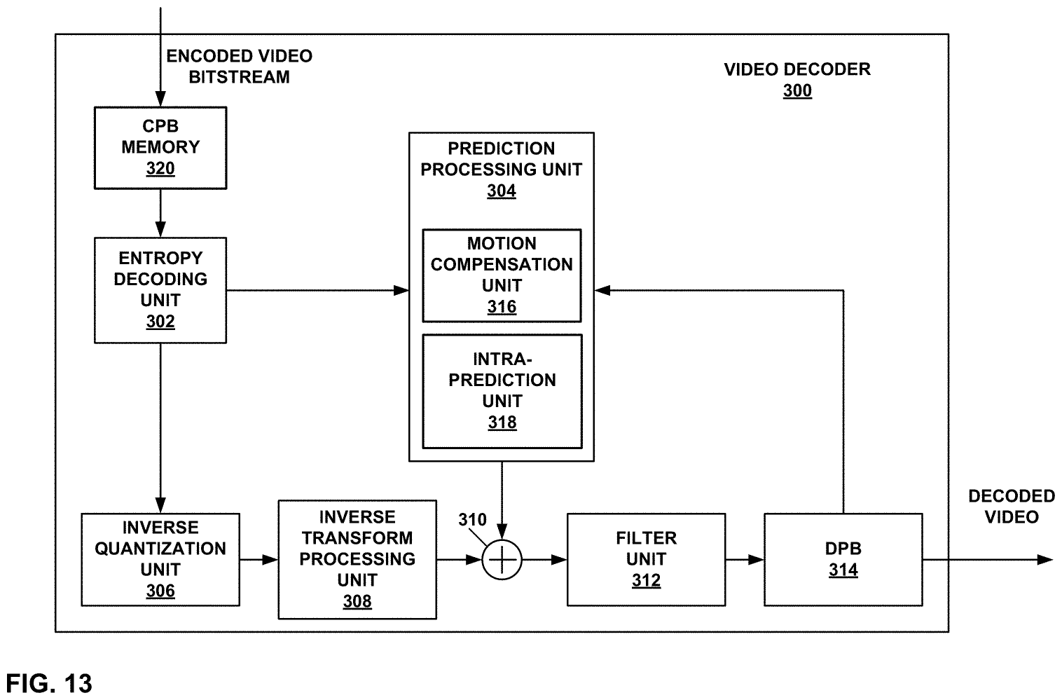

FIG. 13 is a block diagram illustrating an example video decoder 300 that may perform the techniques of this disclosure. FIG. 13 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 13, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 13 are illustrated to assist with understanding the operations performed by video decoder 300. The units may be implemented as fixed-function circuits, programmable circuits, or a combination thereof. Similar to FIG. 12, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Entropy decoding unit 302 may entropy decode intra-prediction information according to any of the various techniques of this disclosure to determine an intra-prediction mode, and pass an indication of the intra-prediction mode to intra-prediction unit 318. Prediction processing unit 304, inverse quantization unit 306, inverse transform processing unit 308, reconstruction unit 310, and filter unit 312 may generate decoded video data based on the syntax elements extracted from the bitstream.

Entropy decoding unit 302 may, according to the techniques of this disclosure, entropy decode data representative of the intra-prediction mode used to predict the current block. For example, entropy decoding unit 302 may entropy decode a value for a syntax element indicating whether a regular intra-prediction mode is used to predict the block. The syntax element may be, for example, regular_intra_flag as discussed above. As noted above, regular_intra_flag may be entropy decoded before other non-regular intra mode flags, e.g., MIP flag, ISP flag, and reference index signaling. Additionally, entropy decoding unit 302 may entropy decode data of a high level syntax element, such as a syntax element of an SPS, indicating whether the regular_intra_flag syntax element is present in the block syntax structure.

Furthermore, according to the techniques of this disclosure and as discussed above, entropy decoding unit 302 may, when the current block is predicted using a regular intra-prediction mode, avoid entropy decoding syntax elements for other non-regular intra-prediction modes, e.g., MIP, ISP, BDPCM, or the like. That is, entropy decoding unit 302 may determine that the bitstream does not include values for these syntax elements, and therefore, entropy decoding unit 302 may entirely skip decoding of values for the syntax elements for non-regular entropy prediction modes. Furthermore, entropy decoding unit 302 may entropy decode an indication of the regular intra-prediction mode using, e.g., an indication of whether the regular intra-prediction mode is included in an MPM list, and either an index into the MPM list or an MPM remainder accordingly. If instead the current block is predicted using a non-regular intra-prediction mode, entropy decoding unit 302 may entropy decode one or more of the non-regular intra-prediction syntax elements.

Entropy decoding unit 302 may provide an indication of the intra-prediction mode for the current block to intra-prediction unit 318. The intra-prediction mode may be a regular intra-prediction mode or a non-regular intra-prediction mode. The regular intra-prediction modes may include directional modes, DC mode, and planar mode. The non-regular intra-prediction modes may include other modes, such as ISP mode, MIP mode, and BDPCM mode, or other intra-prediction modes beyond directional modes, DC mode, and planar mode.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 12).

As another example, if the prediction information syntax elements indicate that the current block is intra-predicted, intra-prediction unit 318 may generate the prediction block according to an intra-prediction mode indicated by the prediction information syntax elements, e.g., as discussed above. Again, intra-prediction unit 318 may generally perform the intra-prediction process in a manner that is substantially similar to that described with respect to intra-prediction unit 226 (FIG. 12). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB 314 for subsequent presentation on a display device, such as display device 118 of FIG. 1.

In this manner, video decoder 300 represents an example of a device for coding video data including a memory configured to store video data; and one or more processors implemented in circuitry and configured to: code a value of a syntax element for a block of the video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; form a prediction block for the block according to the value of the syntax element; and code the block using the prediction block.

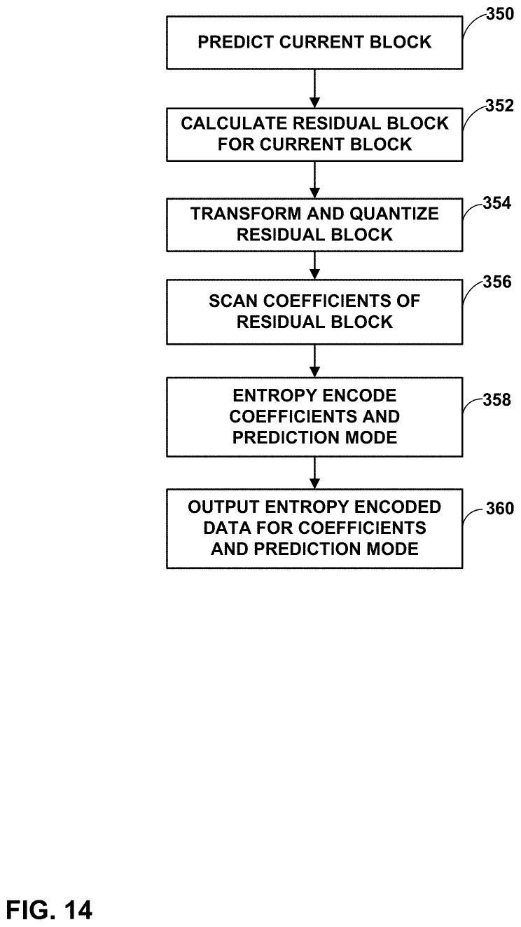

FIG. 14 is a flowchart illustrating an example method for encoding a current block in accordance with the techniques of this disclosure. The current block may comprise a current CU. Although described with respect to video encoder 200 (FIGS. 1 and 12), it should be understood that other devices may be configured to perform a method similar to that of FIG. 14.

In this example, video encoder 200 initially predicts the current block (350). For example, video encoder 200 may form a prediction block for the current block. In accordance with the techniques of this disclosure, video encoder 200 may form the prediction block using a particular intra-prediction mode. Video encoder 200 may then calculate a residual block for the current block (352). To calculate the residual block, video encoder 200 may calculate a difference between the original, uncoded block and the prediction block for the current block. Video encoder 200 may then transform and quantize coefficients of the residual block (354). Next, video encoder 200 may scan the quantized transform coefficients of the residual block (356).

During the scan, or following the scan, video encoder 200 may entropy encode the coefficients, as well as an indication of the prediction mode (358). Video encoder 200 may entropy encode data representing the intra-prediction mode used to form the prediction block according to any of the various techniques of this disclosure. For example, video encoder 200 (and in particular, entropy encoding unit 220) may encode a value for a syntax element indicating whether the current block is predicted using a regular intra-prediction mode, that is, an intra-prediction mode using a zero reference line index that is not ISP partitioning mode, MIP mode, or BDPCM mode. If the intra-prediction mode is a regular intra-prediction mode, video encoder 200 may skip encoding of values for syntax elements relating to other intra-prediction modes. Furthermore, as discussed above, video encoder 200 may entropy encode an MLM index or MLM remainder to indicate a regular intra-prediction mode. If the intra-prediction mode is not a regular intra-prediction mode, video encoder 200 may encode values for syntax elements for, e.g., the ISP mode, the MIP mode, the BDPCM mode, or another non-regular mode. Video encoder 200 may then output the entropy coded data of the block (360).

In this manner, the method of FIG. 14 represents an example of a method of coding video data including coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; forming a prediction block for the block according to the value of the syntax element; and coding the block using the prediction block.

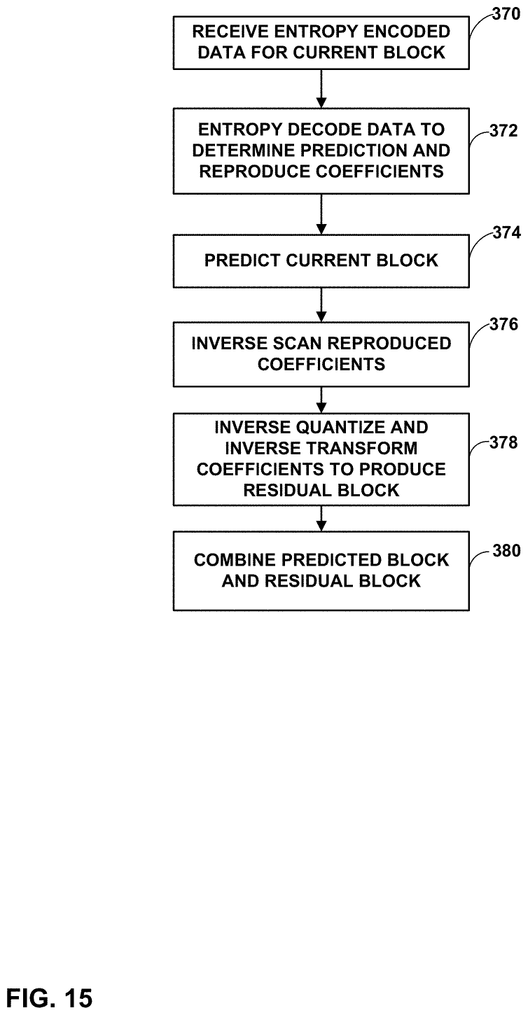

FIG. 15 is a flowchart illustrating an example method for decoding a current block in accordance with the techniques of this disclosure. The current block may comprise a current CU. Although described with respect to video decoder 300 (FIGS. 1 and 13), it should be understood that other devices may be configured to perform a method similar to that of FIG. 15.

Video decoder 300 may receive entropy encoded data for the current block, such as entropy encoded prediction information and entropy encoded data for coefficients of a residual block corresponding to the current block (370). Video decoder 300 may entropy decode the entropy encoded data to determine prediction information for the current block and to reproduce coefficients of the residual block (372). Video decoder 300 may decode an indication of an intra-prediction mode for the current block according to any of the various techniques of this disclosure.

In accordance with the techniques of this disclosure, the entropy encoded prediction information may include an indication of whether the current block is predicted using a regular intra-prediction mode, that is, an intra-prediction mode using a zero reference line index that is not ISP partitioning mode, MIP mode, or BDPCM mode. If the intra-prediction mode is a regular intra-prediction mode, video decoder 300 may determine that values for syntax elements relating to other intra-prediction modes are not included in the bitstream, and therefore may skip attempting to decode values for these syntax elements. Furthermore, as discussed above, video decoder 300 may entropy decode an MLM index or MLM remainder to indicate a regular intra-prediction mode. If the intra-prediction mode is not a regular intra-prediction mode, video decoder 300 may decode values for syntax elements for, e.g., the ISP mode, the MIP mode, the BDPCM mode, or another non-regular mode.

Video decoder 300 may predict the current block (374) using the intra-prediction mode as indicated by the prediction information for the current block, to generate a prediction block for the current block. Video decoder 300 may then inverse scan the reproduced coefficients (376), to create a block of quantized transform coefficients. Video decoder 300 may then inverse quantize and inverse transform the coefficients to produce a residual block (378). Video decoder 300 may ultimately decode the current block by combining the prediction block and the residual block (380).

In this manner, the method of FIG. 15 represents an example of a method of coding video data including coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; forming a prediction block for the block according to the value of the syntax element; and coding the block using the prediction block.

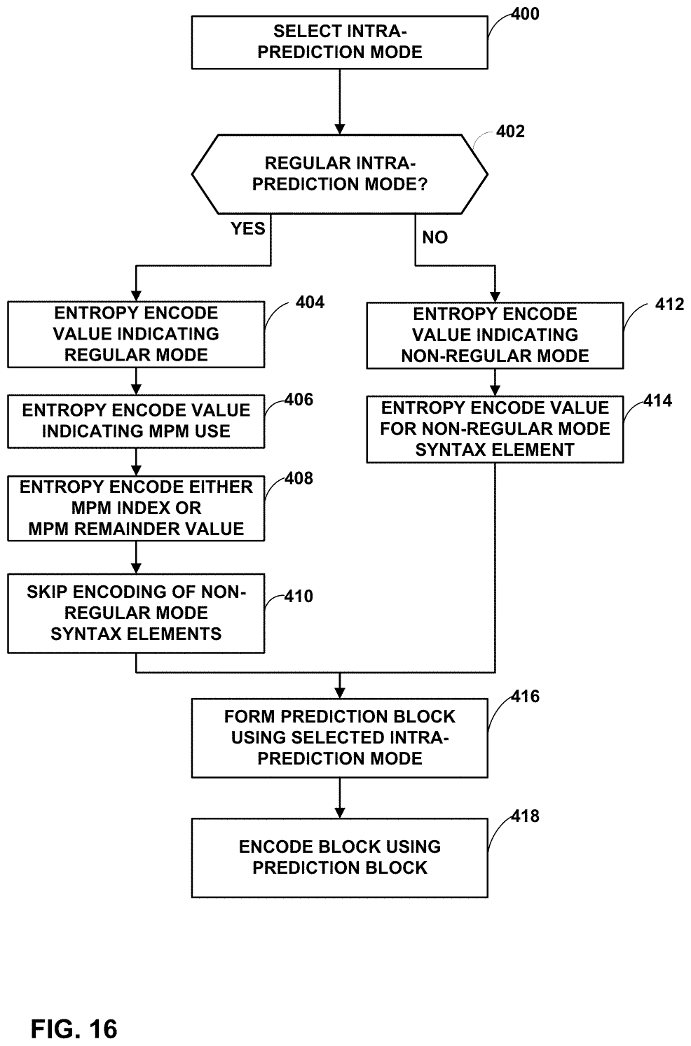

FIG. 16 is a flowchart illustrating an example method for entropy encoding prediction information for an intra-prediction mode according to techniques of this disclosure. Although described with respect to video encoder 200 (FIGS. 1 and 12), it should be understood that other devices may be configured to perform a method similar to that of FIG. 16.

Initially, video encoder 200 (e.g., mode selection unit 202) may select an intra-prediction mode (400) for a current block of video data. As explained above, video encoder 200 may perform a rate-distortion optimization (RDO) process to select the intra-prediction mode, which may be an intra-prediction mode that yields the best RDO metric among other tested modes. Mode selection unit 202 may provide an indication of the selected intra-prediction mode to entropy encoding unit 220.

Entropy encoding unit 220 may determine whether the intra-prediction mode is a regular intra-prediction mode (402). If the intra-prediction mode is a regular intra-prediction mode (“YES” branch of 402), entropy encoding unit 220 may entropy encode a value indicating that the selected mode is a regular intra-prediction mode (404). For example, entropy encoding unit 220 may encode a value of ‘1’ for a regular_intra_flag syntax element, as discussed above. The regular intra-prediction mode may be an intra-prediction mode using a zero reference line index.

Entropy encoding unit 220 may also entropy encode a value indicating whether the selected intra-prediction mode is included in an MPM list, that is, a value indicating MPM use (406), e.g., the intra_luma_mpm_flag discussed above. Entropy encoding unit 220 may then entropy encode either an MPM index or an MPM remainder value (408). In particular, if the value for the MPM use indicates that the MPM is used, entropy encoding unit 220 may encode an MPM index identifying the intra-prediction mode in the MPM list (e.g., intra_luma_mpm_idx), or if the MPM is not used, an MPM remainder representing the intra-prediction mode (e.g., intra_luma_mpm_remainder). Furthermore, entropy encoding unit 220 may skip encoding of values for non-regular intra-prediction mode syntax elements (410), thereby preventing those values from forming part of the bitstream.

On the other hand, if the intra-prediction mode is not a regular intra-prediction mode (“NO” branch of 402), entropy encoding unit 220 may entropy encode a value indicating that the intra-prediction mode is a non-regular mode (412), e.g., a value of ‘0’ for the regular_intra_flag above. Entropy encoding unit 220 may further entropy encode a value for a non-regular intra-prediction mode syntax element (414), e.g., one or more of an intra_bdpcm_flag, an intra_mip_flag, an intra_luma_ref_idx, and/or an intra_subpartitions_mode_flag, and corresponding data representing the selected intra-prediction mode.

Video encoder 200 (in particular, intra-prediction unit 226) may then form a prediction block using the selected intra-prediction mode (416). Video encoder 200 may also encode the current block using the prediction block (418). For example, video encoder 200 may calculate a residual representing differences between the current block and the prediction block, transform and quantize the residual block, and then entropy encode the quantized transform coefficients, as discussed above.

In this manner, the method of FIG. 16 represents an example of a method of coding video data including coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode; forming a prediction block for the block according to the value of the syntax element; and coding the block using the prediction block.

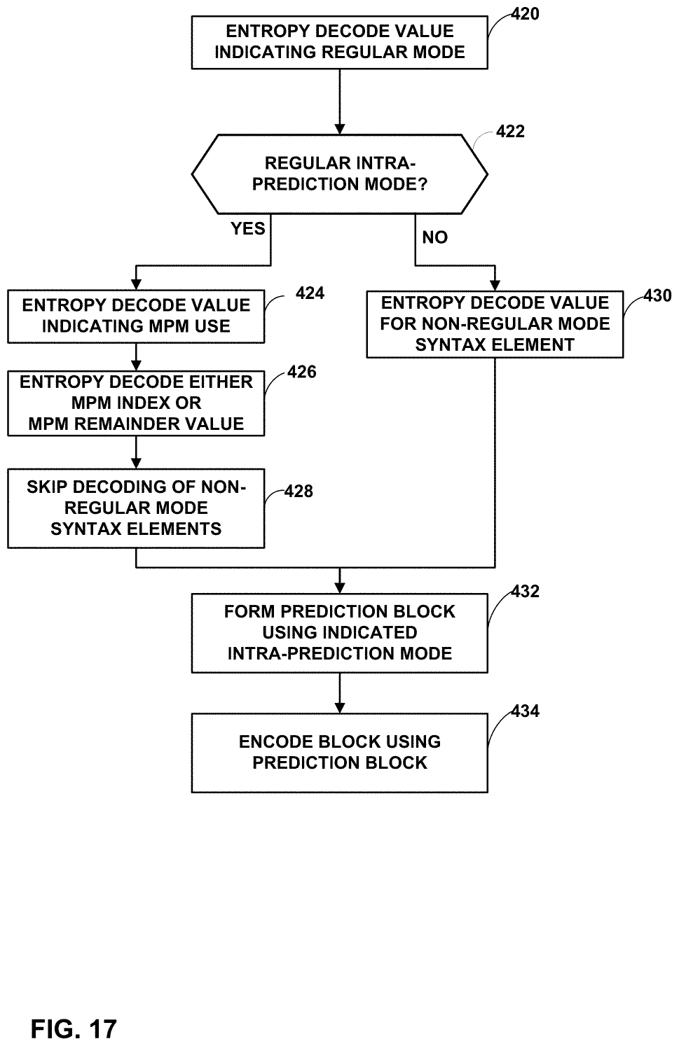

FIG. 17 is a flowchart illustrating an example method for entropy decoding prediction information for an intra-prediction mode according to techniques of this disclosure. Although described with respect to video decoder 300 (FIGS. 1 and 13), it should be understood that other devices may be configured to perform a method similar to that of FIG. 17.

Initially, entropy decoding unit 302 may decode a value indicating whether an intra-prediction mode for a current block is a regular intra-prediction mode (420), that is, an intra-prediction mode using a zero reference line index. Entropy decoding unit 302 may then determine whether the intra-prediction mode is the regular intra-prediction mode (422).

If the intra-prediction mode is a regular intra-prediction mode (“YES” branch of 422), entropy decoding unit 302 may also entropy decode a value indicating whether the selected intra-prediction mode is included in an MPM list, that is, a value indicating MPM use (424), e.g., the intra_luma_mpm_flag discussed above. Entropy decoding unit 302 may then entropy decode either an MPM index or an MPM remainder value (426). In particular, if the value for the MPM use indicates that the MPM is used, entropy decoding unit 302 may decode an MPM index identifying the intra-prediction mode in the MPM list (e.g., intra_luma_mpm_idx), or if the MPM is not used, an MPM remainder representing the intra-prediction mode (e.g., intra_luma_mpm_remainder). Furthermore, entropy decoding unit 302 may skip decoding of values for non-regular intra-prediction mode syntax elements (428). Moreover, entropy decoding unit 302 may be constructed on the basis that these syntax elements do not form part of the bitstream under these conditions, and thus, may treat the bits of the bitstream as corresponding to other syntax elements.

On the other hand, if the intra-prediction mode is not a regular intra-prediction mode (“NO” branch of 422), entropy decoding unit 302 may entropy decode a value for a non-regular intra-prediction mode syntax element (430), e.g., one or more of an intra_bdpcm_flag, an intra_mip_flag, an intra_luma_ref_idx, and/or an intra_subpartitions_mode_flag, and corresponding data representing the selected intra-prediction mode.

Video decoder 300 (in particular, intra-prediction unit 318) may then form a prediction block using the selected intra-prediction mode (416). Video decoder 300 may also decode the current block using the prediction block (418). For example, video decoder 300 may decode quantized transform coefficients, inverse quantize and inverse transform the quantized transform coefficients to reproduce a residual block, and add samples of the residual block to corresponding samples of the prediction block to reproduce the current block.

In this manner, the method of FIG. 17 represents an example of a method of coding video data including coding a value of a syntax element for a block of video data, the syntax element indicating whether the block is decoded using an intra-prediction mode using a zero reference line index, not decoded using intra sub-partition coding (ISP) partitioning mode, not decoded using matrix intra-prediction (MIP) mode, and not decoded using blurred differential pulse code modulation (BDPCM) mode; forming a prediction block for the block according to the value of the syntax element; and coding the block using the prediction block.

Techniques of this disclosure are summarized in the following examples:

Example 1: A method of coding video data, the method comprising: coding a value of a syntax element for a block of video data, the syntax element indicating whether the block is encoded using planar prediction mode with a reference index equal to zero, not being encoded using matrix intra prediction (MIP) mode, and not being encoded using intra sub-partition coding (ISP) partitioning; forming a prediction block for the block according to the value of the syntax element; and coding the block using the prediction block.

Example 2: The method of example 1, further comprising, in response to the value for the syntax element indicating that the block is encoded using the planar prediction mode with the reference index equal to zero, preventing coding of any further bits related to intra prediction mode for the block.

Example 3: The method of any of examples 1 and 2, wherein coding the value comprises coding the value at a position in a bitstream including the video data, the position being determined according to probabilities of intra prediction modes for the block.

Example 4: The method of any of examples 1-3, wherein the syntax element comprises a reg_intra_planar_flag syntax element.

Example 5: The method of any of examples 1-4, wherein a position of the syntax element in a bitstream including the video data occurs before a position of a syntax element indicating whether the block is intra predicted without planar mode.

Example 6: The method of example 5, wherein the syntax element indicating whether the block is intra predicted without planar mode comprises an intra_luma_not_planar_flag.

Example 7: The method of any of examples 5 and 6, further comprising coding a value for the syntax element indicating whether the block is intra predicted without planar mode only when the value for the syntax element indicating whether the block is encoded using planar prediction mode with a reference index equal to zero indicates that the block is not encoded using planar prediction mode with the reference index equal to zero.

Example 8: The method of any of examples 1-7, wherein a position of the syntax element in a bitstream including the video data occurs before positions of syntax elements indicating whether the block is coded using one or more of blurred differential pulse code modulation (BDPCM) mode, pulse code modulation (PCM) mode, MIP mode, ISP mode, or reference index coding mode.

Example 9: The method of any of examples 1-8, wherein forming the prediction block comprises: when the value of the syntax element indicates that the block is encoded using planar prediction mode with the reference index equal to zero, forming the prediction block using planar prediction mode; or when the value of the syntax element indicates that the block is not encoded using planar prediction mode with the reference index equal to zero, forming the prediction block using a prediction mode other than planar prediction mode with the reference index equal to zero.

Example 10: The method of example 9, wherein the prediction mode other than planar prediction mode with the reference index equal to zero comprises one of MIP mode or ISP mode.

Example 11: A method of coding video data, the method comprising: coding a value of a syntax element for a block of video data, the syntax element indicating whether the block is encoded using a zero reference line index, not being encoded using intra sub-partition coding (ISP) partitioning, not being encoded using matrix intra prediction (MIP) mode, and not being encoded using blurred differential pulse code modulation (BDPCM) mode; forming a prediction block for the block according to the value of the syntax element; and coding the block using the prediction block.

Example 12: A method comprising the method of any of examples 1-10 and the method of example 11.

Example 13: The method of any of examples 11 and 12, further comprising, when the value of the syntax element indicates that the block is encoded using the zero reference line index, preventing coding of additional bits related to ISP partitioning, MIP mode, and BDPCM mode for the block.

Example 14: The method of any of examples 11-13, wherein coding the value comprises coding the value at a position in a bitstream including the video data, the position being determined according to probabilities of intra prediction modes for the block.

Example 15: The method of any of examples 11-14, wherein a position of the syntax element in a bitstream including the video data is before syntax elements for all other intra modes for the block in the bitstream.

Example 16: The method of any of examples 11-14, wherein a position of the syntax element in a bitstream including the video data is after an ISP partitioning syntax element in the bitstream.

Example 17: The method of any of examples 11-16, wherein coding the value of the syntax element comprises entropy coding the value using bypass coding.

Example 18: The method of any of examples 11-16, wherein coding the value of the syntax element comprises entropy coding the value using one or more contexts.

Example 19: The method of example 18, further comprising determining the one or more contexts using data from one or more neighboring blocks to the block.

Example 20: The method of any of examples 18 and 19, further comprising determining the one or more contexts according to a size of the block.

Example 21: The method of any of examples 11-20, further comprising coding a value for a high level syntax element indicating that the value of the syntax element is present in a bitstream including the video data.

Example 22: The method of example 21, wherein the high level syntax element comprises regular_intra_flag_present.

Example 23: The method of any of examples 21 and 22, wherein coding the value for the high level syntax element comprises coding the value for the high level syntax element in a sequence parameter set (SPS), a picture parameter set (PPS), a video parameter set (VPS), a slice header, a tile header, or a brick header.

Example 24: The method of any of examples 11-23, wherein forming the prediction block comprises: when the value of the syntax element indicates that the block is encoded using zero reference line index mode, forming the prediction block using zero reference line index mode; or when the value of the syntax element indicates that the block is not encoded using zero reference line index mode, forming the prediction block using a prediction mode other than zero reference line index mode.

Example 25: A method of coding video data, the method comprising: coding a value of a syntax element for a block of video data, the syntax element indicating whether the block is encoded using a regular intra mode of a most probable mode (MPM) list and not using pulse code modulation (PCM), intra sub-partition coding (ISP) partitioning, multiple reference line (MRL) prediction mode, and blurred differential pulse code modulation (BDPCM) mode; forming a prediction block for the block according to the value of the syntax element; and coding the block using the prediction block.

Example 26: A method comprising the method of any of examples 1-24 and the method of example 25.

Example 27: The method of any of examples 25 and 26, wherein a position of the syntax element in a bitstream including the video data is before syntax elements indicating other modes for the block in the bitstream.

Example 28: The method of any of examples 25-27, wherein a position of the syntax element in a bitstream including the video data is after a syntax element indicating whether the block is predicted using matrix intra prediction (MIP) mode.

Example 29: The method of any of examples 25-28, wherein forming the prediction block comprises: when the value of the syntax element indicates that the block is encoded using the regular intra mode, determining an intra mode using the MPM list and forming the prediction block using the determined intra mode; or when the value of the syntax element indicates that the block is not encoded using the regular intra mode, forming the prediction block using a prediction mode other than the regular intra mode.

Example 30: The method of any of examples 25-29, wherein coding the value of the syntax element comprises coding the value of the syntax element using a context, the method further comprising determining the context according to a size of the block.

Example 31: The method of any of examples 25-29, wherein coding the value of the syntax element comprises coding the value of the syntax element using a context, the method further comprising determining the context according to a slice type for a slice including the block.

Example 32: A method of coding video data, the method comprising: coding a value of a syntax element for a block of video data, the syntax element indicating a type of intra mode coding used for the block; coding a value of a syntax element indicating whether a most probable mode (MPM) list is used to determine an intra mode for the block; when the value of the syntax element indicating whether the MPM list is used indicates that the MPM list is used, coding a value for a syntax element indicating an MPM index into the MPM list for the block; when the value of the syntax element indicating whether the MPM list is used indicates that the MPM list is not used, coding a value for a syntax element indicating an MPM remainder for the block; forming a prediction block for the block according to the values of the syntax elements; and coding the block using the prediction block.

Example 33: A method comprising the method of any of examples 1-31 and the method of example 32.

Example 34: A method of coding video data, the method comprising: coding a value for a syntax element for a chrominance (chroma) block of video data, the value indicating that the chroma block is coded using direct mode (DM); determining that a luminance (luma) block corresponding to the chroma block is coded using either pulse code modulation (PCM) mode or intra-block copy (IBC) mode; in response to the value indicating that the chroma block is coded using DM and the luma block being coded using PCM or IBC mode, determining a default prediction mode for the chroma block; forming a prediction block for the block using the default prediction mode; and coding the block using the prediction block.

Example 35: A method comprising the method of any of examples 1-33 and the method of example 34.

Example 36: The method of any of examples 34 and 35, wherein the default prediction mode comprises planar mode.

Example 37: The method of any of examples 34 and 35, wherein when the luma block is coded using the IBC mode, the default prediction mode comprises vertical prediction mode.

Example 38: The method of any of examples 34 and 35, wherein when the luma block is coded using the IBC mode, the default prediction mode comprises horizontal prediction mode.

Example 39: The method of any of examples 34 and 35, wherein when the luma block is coded using the IBC mode, the default mode comprises planar mode.

Example 40: The method of any of examples 1-39, wherein coding the block using the prediction block comprises: decoding transform coefficients for the block; applying an inverse transform to the transform coefficients to produce a residual block for the block; and combining the residual block with the prediction block to decode the block.

Example 41: The method of any of examples 1-40, wherein coding the block using the prediction block comprises: subtracting the prediction block from the block to produce a residual block for the block; applying a transform to the residual block to produce transform coefficients for the block; and encoding the transform coefficients to encode the block.

Example 42: A device for coding video data, the device comprising one or more means for performing the method of any of examples 1-41.

Example 43: The device of example 42, wherein the one or more means comprise one or more processors implemented in circuitry.

Example 44: The device of example 42, further comprising a display configured to display decoded video data.

Example 45: The device of example 42, wherein the device comprises one or more of a camera, a computer, a mobile device, a broadcast receiver device, or a set-top box.

Example 46: The device of example 42, further comprising a memory configured to store video data.

Example 47: A computer-readable storage medium having stored thereon instructions that, when executed, cause a processor to perform the method of any of examples 1-41.

Example 48: A device for coding video data, the device comprising: means for coding a value of a syntax element for a block of video data, the syntax element indicating whether the block is encoded using planar prediction mode with a reference index equal to zero, not being encoded using matrix intra prediction (MIP) mode, and not being encoded using intra sub-partition coding (ISP) partitioning; means for forming a prediction block for the block according to the value of the syntax element; and means for coding the block using the prediction block.

Example 49: A device for coding video data, the device comprising: means for coding a value of a syntax element for a block of video data, the syntax element indicating whether the block is encoded using a zero reference line index, not being encoded using intra sub-partition coding (ISP) partitioning, not being encoded using matrix intra prediction (MIP) mode, and not being encoded using blurred differential pulse code modulation (BDPCM) mode; means for forming a prediction block for the block according to the value of the syntax element; and means for coding the block using the prediction block.

Example 50: A device for coding video data, the device comprising: means for coding a value of a syntax element for a block of video data, the syntax element indicating whether the block is encoded using a regular intra mode of a most probable mode (MPM) list and not using pulse code modulation (PCM), intra sub-partition coding (ISP) partitioning, multiple reference line (MRL) prediction mode, and blurred differential pulse code modulation (BDPCM) mode; means for forming a prediction block for the block according to the value of the syntax element; and means for coding the block using the prediction block.

Example 51: A device for coding video data, the device comprising: means for coding a value of a syntax element for a block of video data, the syntax element indicating a type of intra mode coding used for the block; means for coding a value of a syntax element indicating whether a most probable mode (MPM) list is used to determine an intra mode for the block; means for coding, when the value of the syntax element indicating whether the MPM list is used indicates that the MPM list is used, a value for a syntax element indicating an MPM index into the MPM list for the block; means for coding, when the value of the syntax element indicating whether the MPM list is used indicates that the MPM list is not used, a value for a syntax element indicating an MPM remainder for the block; means for forming a prediction block for the block according to the values of the syntax elements; and means for coding the block using the prediction block.

Example 52: A device for coding video data, the device comprising: means for coding a value for a syntax element for a chrominance (chroma) block of video data, the value indicating that the chroma block is coded using direct mode (DM); means for determining that a luminance (luma) block corresponding to the chroma block is coded using either pulse code modulation (PCM) mode or intra-block copy (IBC) mode; means for determining a default prediction mode for the chroma block in response to the value indicating that the chroma block is coded using DM and the luma block being coded using PCM or IBC mode; means for forming a prediction block for the block using the default prediction mode; and means for coding the block using the prediction block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode;
forming a prediction block for the block according to the value of the syntax element; and
coding the block using the prediction block.

2. The method of claim 1, further comprising, when the value of the syntax element indicates that the block is encoded using the intra-prediction mode using the zero reference line index, preventing coding of additional data related to the ISP partitioning mode, the MIP mode, and the BDPCM mode for the block.

3. The method of claim 1, wherein coding the value comprises coding the value at a position in a block syntax structure for the block, the position corresponding to probabilities of possible intra-prediction modes for the block, the possible intra-prediction modes including the intra-prediction mode using the zero reference line index, the ISP partitioning mode, the MIP mode, and the BDPCM mode.

4. The method of claim 1, wherein a position of the syntax element in a block syntax structure is before syntax elements of the block syntax structure for the ISP partitioning mode, the MIP mode, and the BDPCM mode.

5. The method of claim 1, wherein a position of the syntax element in a block syntax structure for the block is after an ISP partitioning mode syntax element in the syntax element.

6. The method of claim 1, wherein coding the value of the syntax element comprises entropy coding the value using bypass coding.

7. The method of claim 1, wherein coding the value of the syntax element comprises entropy coding the value using one or more contexts.

8. The method of claim 7, further comprising determining the one or more contexts using data from one or more neighboring blocks to the block.

9. The method of claim 7, further comprising determining the one or more contexts according to a size of the block.

10. The method of claim 1, further comprising coding a value for a high level syntax element indicating that the value of the syntax element is present in a bitstream including the video data.

11. The method of claim 10, wherein coding the value for the high level syntax element comprises coding the value for the high level syntax element in a sequence parameter set (SPS), a picture parameter set (PPS), a video parameter set (VPS), a slice header, a tile header, or a brick header.

12. The method of claim 1, wherein forming the prediction block comprises:
when the value of the syntax element indicates that the block is encoded using zero reference line index mode, forming the prediction block using zero reference line index mode; or
when the value of the syntax element indicates that the block is not encoded using zero reference line index mode, forming the prediction block using a prediction mode other than zero reference line index mode.

13. The method of claim 1, wherein the intra-prediction mode using the zero reference line index comprises one of a directional intra-prediction mode, a DC prediction mode, or a planar mode.

14. The method of claim 1, wherein the intra-prediction mode using the zero reference index line comprises an intra-prediction mode of a most probable mode (MPM) list.

15. The method of claim 14, further comprising:
coding a value of a syntax element indicating whether the MPM list is used to determine the intra-prediction mode for the block;
when the value of the syntax element indicating whether the MPM list is used indicates that the MPM list is used, coding a value for a syntax element indicating an MPM index into the MPM list for the block; and
when the value of the syntax element indicating whether the MPM list is used indicates that the MPM list is not used, coding a value for a syntax element indicating an MPM remainder for the block.

16. The method of claim 1, wherein coding the block using the prediction block comprises:
decoding transform coefficients for the block;
applying an inverse transform to the transform coefficients to produce a residual block for the block; and
combining the residual block with the prediction block to decode the block.

17. The method of claim 1, wherein coding the block using the prediction block comprises:
subtracting the prediction block from the block to produce a residual block for the block;
applying a transform to the residual block to produce transform coefficients for the block; and
encoding the transform coefficients to encode the block.

18. A device for coding video data, the device comprising:
a memory configured to store video data; and
one or more processors implemented in circuitry and configured to:
code a value of a syntax element for a block of the video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode;
form a prediction block for the block according to the value of the syntax element; and
code the block using the prediction block.

19. The device of claim 18, wherein the one or more processors are further configured to, when the value of the syntax element indicates that the block is encoded using the intra-prediction mode using the zero reference line index, prevent coding of additional data related to the ISP partitioning mode, the MIP mode, and the BDPCM mode for the block.

20. The device of claim 18, wherein the intra-prediction mode using the zero reference index line comprises an intra-prediction mode of a most probable mode (MPM) list, and wherein the one or more processors are further configured to:
code a value of a syntax element indicating whether the MPM list is used to determine the intra-prediction mode for the block;
when the value of the syntax element indicating whether the MPM list is used indicates that the MPM list is used, code a value for a syntax element indicating an MPM index into the MPM list for the block; and
when the value of the syntax element indicating whether the MPM list is used indicates that the MPM list is not used, code a value for a syntax element indicating an MPM remainder for the block.

21. The device of claim 18, wherein a position of the syntax element in a block syntax structure is before syntax elements of the block syntax structure for the ISP partitioning mode, the MIP mode, and the BDPCM mode.

22. The device of claim 18, wherein the device comprises a video decoder, and wherein to code the block using the prediction block, the one or more processors are configured to:
decode transform coefficients for the block;
apply an inverse transform to the transform coefficients to produce a residual block for the block; and
combine the residual block with the prediction block to decode the block.

23. The device of claim 18, further comprising a display configured to display decoded video data.

24. The device of claim 18, wherein the device comprises one or more of a camera, a computer, a mobile device, a broadcast receiver device, or a set-top box.

25. A computer-readable storage medium having stored thereon instructions that, when executed, cause a processor to:
code a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode;
form a prediction block for the block according to the value of the syntax element; and
code the block using the prediction block.

26. The computer-readable storage medium of claim 25, further comprising instructions that cause the processor to, when the value of the syntax element indicates that the block is encoded using the intra-prediction mode using the zero reference line index, prevent coding of additional data related to the ISP partitioning mode, the MIP mode, and the BDPCM mode for the block.

27. The computer-readable storage medium of claim 25, wherein the intra-prediction mode using the zero reference index line comprises an intra-prediction mode of a most probable mode (MPM) list, further comprising instructions that cause the processor to:
code a value of a syntax element indicating whether the MPM list is used to determine the intra-prediction mode for the block;
when the value of the syntax element indicating whether the MPM list is used indicates that the MPM list is used, code a value for a syntax element indicating an MPM index into the MPM list for the block; and
when the value of the syntax element indicating whether the MPM list is used indicates that the MPM list is not used, code a value for a syntax element indicating an MPM remainder for the block.

28. A device for coding video data, the device comprising:
means for coding a value of a syntax element for a block of video data, the syntax element indicating whether the block is encoded using an intra-prediction mode using a zero reference line index, not encoded using intra sub-partition coding (ISP) partitioning mode, not encoded using matrix intra-prediction (MIP) mode, and not encoded using blurred differential pulse code modulation (BDPCM) mode;
means for forming a prediction block for the block according to the value of the syntax element; and
means for coding the block using the prediction block.

29. The device of claim 28, further comprising means for preventing coding of additional data related to the ISP partitioning mode, the MIP mode, and the BDPCM mode for the block when the value of the syntax element indicates that the block is encoded using the intra-prediction mode using the zero reference line index.

30. The device of claim 28, wherein the intra-prediction mode using the zero reference index line comprises an intra-prediction mode of a most probable mode (MPM) list, and further comprising:
means for coding a value of a syntax element indicating whether the MPM list is used to determine the intra-prediction mode for the block;
means for coding a value for a syntax element indicating an MPM index into the MPM list for the block when the value of the syntax element indicating whether the MPM list is used indicates that the MPM list is used; and
means for coding a value for a syntax element indicating an MPM remainder for the block when the value of the syntax element indicating whether the MPM list is used indicates that the MPM list is not used.
